(19) United States
(12) Patent Application Publication
(10) Pub. No.: US 2013/0317929 A1
(43) Pub. Date: Nov. 28, 2013

(54) SYSTEM AND METHOD FOR OPTIMIZING LOGISTICS SOURCING DECISIONS FOR LOGISTICS MANAGEMENT NETWORKS

(71) Applicant: Elemica, Inc., Exton, PA (US)

(72) Inventors: Blake SCHNORF, Exton, PA (US); Armand CASTRO, Exton, PA (US); Neil SHANNON, Atlanta, GA (US); Michael SENGBUSCH, Atlanta, GA (US)

(73) Assignee: ELEMICA, INC., Exton, PA (US)

(21) Appl. No.: 13/676,661

(22) Filed: Nov. 14, 2012

Related U.S. Application Data
(60) Provisional application No. 61/559,405, filed on Nov. 14, 2011.

(51) Int. Cl. G06Q 30/08

(52) U.S. Cl. CPC G06Q 30/08
USPC 705/26.3

(57) ABSTRACT

A preferred method of managing logistics sourcing decisions including shipping rates in a network involves transmitting a shipping bid, receiving a plurality of bid responses from a plurality of carriers including a first bid having a first shipping rate and a first expiration date from the first carrier, receiving a shipping constraint, determining whether the plurality of bid responses meet the shipping constraint to identify a rejected bid and a plurality of accepted bids, storing a plurality of accepted bids until at least their respective expiration dates, receiving a selected bid of the plurality of accepted bids of step, wherein the accepted bid is the first bid, transmitting a booking request to the first carrier and receiving tracking information related to the freight being shipped including a ship date when the freight is received by the first carrier and a receipt date when the freight is delivered to the consignee.

### CROSS-REFERENCE TO RELATED APPLICATIONS

This application claims the benefit of U.S. Provisional Patent Application No. 61/559,405, filed on Nov. 14, 2011, entitled “System and Method for Optimizing Logistics Sourcing Decisions for Logistics Management Networks,” the entire contents of which are incorporated herein by reference in their entirety.

### BACKGROUND OF THE INVENTION

Logistics management is generally considered a portion of supply chain management, which controls, implements and plans the flow and storage of goods and information between shippers and a consignee who receives the goods and/or information and may consume the goods or otherwise utilize the information. Logistics management and supply chain management were traditionally controlled, organized and staffed by a company who produced goods and an internal staff that managed the flow of the goods from the point of origin to the point of sale and/or consumption. These traditional methods were often labor intensive, relied on manual tracking, were not part of the company's core business operations, were difficult to organize and/or were difficult to optimize. The logistics and/or supply management personnel would contact multiple carriers for bidding, organize their responses, allocate business, attempt to track shipments and otherwise manually plan and operate the logistics and supply chain management for the organization. The task or tasks for the supply chain and logistics management personnel become exponentially more complicated when dealing with international shipments and various links in the shipment chain from land, to sea, to air across borders and otherwise through modes, methods and locations in the supply chain.

It would be desirable to develop and implement an on-demand solution that is universally accessible for transportation bid management, optimization and tracking. Such a system is preferably able to collect, rationalize and manage global shipping lanes, work in a collaborative and online environment between carriers, shippers and consignees and benefit from easy self-service event management. The system is preferably able to implement robust scenarios and constraints and provide real-time analysis to carriers, shippers and consignees. Allocation of tasks are preferably updatable with respect to lane, event and rate data. The system is preferably continually available to source or re-source rates using spot or mini-events utilized to optimize shipper defined strategies and provide real-time analysis and results. The preferred system and method for optimizing logistics sourcing decisions for logistics management networks addresses the deficiencies of the above-identified traditional systems and implements the above-described desirable systems and methods for logistics and supply chain management.

### BRIEF SUMMARY OF THE INVENTION

Briefly stated, a preferred method of the present invention is directed to managing logistics sourcing decisions including shipping rates in a logistics management network having a consignee, a plurality of carriers and a shipper for shipping freight from the shipper to the consignee. The method includes transmitting, by a central server, a shipping bid to the plurality of carriers, receiving, at the central server, a plurality of bid responses from the plurality of carriers in response to the shipping bid and receiving, at the central server, a shipping constraint from the shipper and/or the consignee. The shipper typically transmits or inputs shipping constraints if they are paying for the shipment and, likewise, the consignee typically transmits or inputs the shipping constraints to the central server if they are paying for the shipment, although the application is not so limited. The plurality of bid responses include at least a first bid having a first shipping rate and a first expiration date from a first carrier. The preferred method also includes the steps of determining, by the central server, whether the plurality of bid responses meet the shipping constraint to identify a rejected bid of the plurality of bid responses and determining, by the central server, whether the plurality of bid responses meet the shipping constraint to identify a plurality of accepted bids of the plurality of bid responses. The central server transmits a rejection notification to a rejected carrier of the plurality of carriers associated with the rejected bid. The central server also transmits a plurality of acceptance notifications to a plurality of accepted carriers of the plurality of carriers. The plurality of accepted bids includes at least the first bid. The preferred method also includes the steps of storing, at the central server, the plurality of accepted bids, receiving, by the central server a selected bid of the plurality of accepted bids and transmitting, by the central server, a booking request to the first carrier. The plurality of accepted bids are stored until at least their respective expiration dates and the selected bid is comprised of the first bid. The method also preferably includes the step of receiving, at the central server, tracking information related to the freight being shipped by the first carrier to the consignee including a ship date when the freight is received by the first carrier and a receipt date when the freight is delivered to the consignee.

The preferred logistics sourcing and supply chain management system and methods of the present invention are able to increase the rate at which value is driven and reduce total costs for users by creating a competitive environment, defining scenarios, intelligently awarding contracts, minimizing time spent managing logistics, sourcing and supply chain management, lowering resource requirements by supplying products and or information on time and in required quantities and related advantages. The preferred system and methods permit the execution of a greater number of events, permit realization of benefits in shorter amounts of time, such as days versus months, accelerates time to completion and permits quick and disruption free implementation. The intelligent analysis and optimization of the preferred systems and methods results in understanding of true costs of supply chain strategies, universally accessible and real-time information related to supply chain strategies, general elimination of error-prone manual processes and nearly limitless optimization possibilities for the systems and methods.

The preferred logistics sourcing and optimization system is an advanced on-demand solution which is universally accessible for transportation bid management. Transportation and logistics teams implementing the preferred system and methods will collect, rationalize and manage global shipping lanes, work in a collaborative and online environment and benefit from easy self-service event management. The optimization engine of the preferred system is preferably combined with a robust scenario and constraint builder and provides real-time analysis. Contract allocation for supply chain management is preferably based on online and up-to-date lane, event and rate data, continued availability to source or re-source rates using spot or mini-events, optimized shipper defined strategies and real-time analysis and results.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram showing the flow of information and freight in accordance with a first preferred embodiment of the system and method for optimizing logistics sourcing decisions for logistics management networks of the present invention;

FIG. 2 is a flow chart showing the flow of information in a second preferred embodiment of the system and method for optimizing logistics sourcing decisions for logistics management networks of the present invention;

FIG. 3 is a lane management graphical user interface (“GUI”) of the preferred systems presented on a display showing filtering options for the preferred systems of the present invention;

FIG. 4 is the lane management GUI of FIG. 3 with a preferred lane history and edit lane GUIs showing additional potential restraint options for the preferred systems;

FIG. 5 is a consignee events GUI showing the tracking of information in the preferred system of the present invention;

FIG. 6 is a carrier's view events GUI of the preferred systems;

FIG. 7 is a bid upload GUI of the preferred systems;

FIG. 8 is a scenario management GUI of the preferred systems;

FIG. 9 is a constraints GUI of the preferred systems;

FIG. 10 is an optimization analysis GUI of the preferred systems;

FIG. 11 is a rate dashboard GUI of the preferred systems;

FIG. 12 is a rate management GUI of the preferred systems;

FIG. 13 is the rate management GUI of FIG. 12, with edit rate and download rates GUI's displayed thereon of the preferred systems;

FIG. 14 is the rate management GUI of FIG. 12, with a main attributed GUI displayed thereon of the preferred systems;

FIG. 15 is a preferred depiction of sailing schedules and view schedules GUI's of the preferred systems;

FIG. 16 is a booking GUI of the preferred systems;

FIG. 17 is a shipping instructions GUI of the preferred systems;

FIG. 18 is a shipment tracking GUI of the preferred systems;

FIG. 19 is an order status GUI of the preferred systems;

FIG. 20 is an optimizer process flow diagram of the preferred systems; and

FIG. 21 is a spend GUI of the preferred systems.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right,” “left,” “lower,” and “upper” designate directions in the drawings to which reference is made. The terminology includes the above-listed words, derivatives thereof and words of similar import.

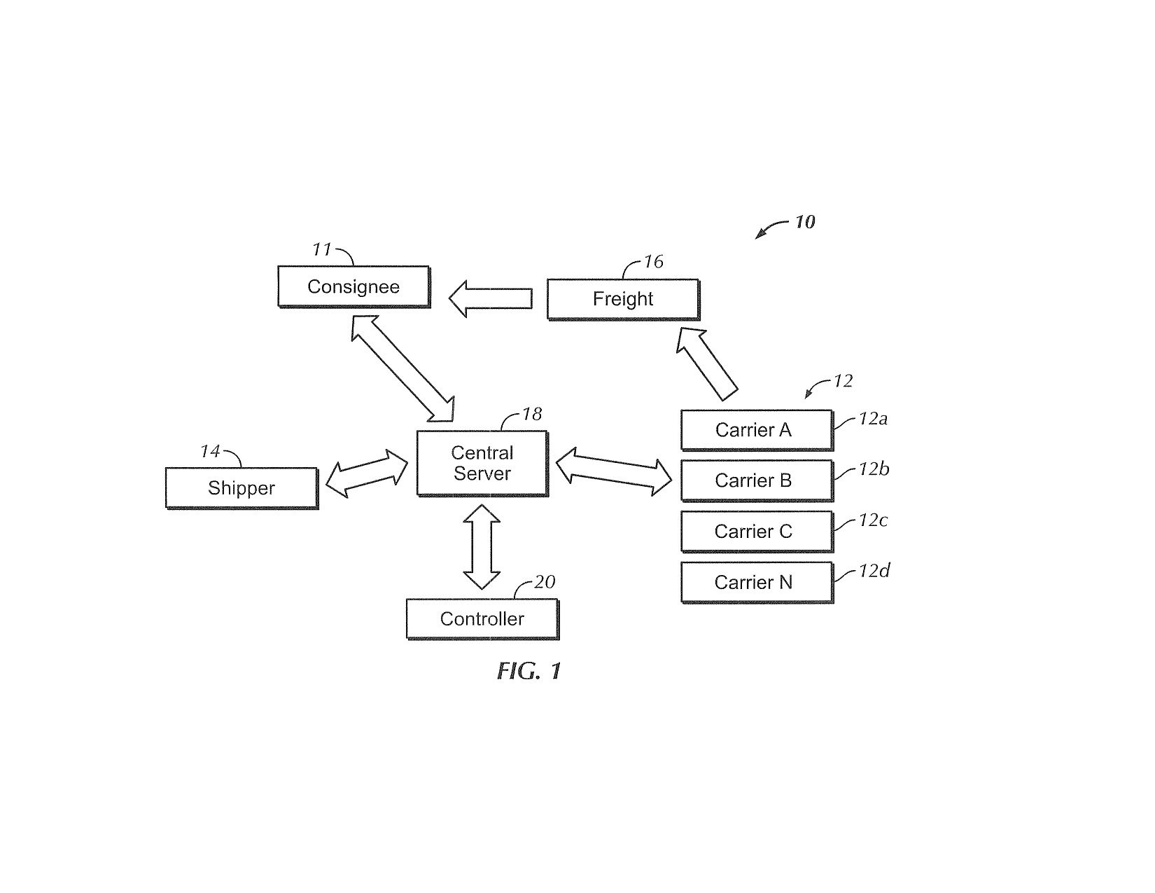

Referring to FIG. 1, a first preferred embodiment of the present invention is directed to a method of managing logistics sourcing decisions with a logistics management system or network, generally designated 10, including shipping rates. The first preferred logistics management network 10 includes a consignee 11, a plurality of carriers 12a, 12b, 12c, 12n, generally designated 12, and a shipper 14 for shipping freight 16 from the shipper 14 to the consignee 11. The first preferred system or network 10 includes a central server 18 that receives information from and transmits information to the shipper 14, the consignee 11, the plurality of carriers 12 and any other members or participants in the first preferred system or network 10. The first preferred central server 18 is not limited to a specific type or variety of server or any particular type or variety of hardware and may be comprised of nearly any configuration of components, hardware or configuration that is able to facilitate the preferred functions of the central server 18, as described below, and communicate the appropriate information to the preferred members of the network 10.

The central server 18 may be comprised of a parallel computing network with the ability to share computing resources among multiple applications and multiple users. The central server 18 may employ access over a network, such as the internet. The central server 18 may be configured for sharing resources in a Cloud computing environment, wherein a provider organization allows other organizations or users to use computing resources (processers, memory, servers, bandwidth and the like) for a fee. The Cloud computing environment preferably allows the users of the network 10 on-demand access to a larger amount of computing resources than may otherwise be available, generally without the need to maintain those resources internally.

The first preferred system or network 10 also preferably includes a controller 20 that is in communication with the central server 18. The controller 20 is generally able to access all of the information stored in the central server 18, imbed ruled or constraints, edit and revise the information and otherwise manipulate the operation of the central server 18. The controller 20 is also preferably able to prepare, edit and employ rules for operation of the central server 18 access to information in the central server by the consignee 11, shipper 14 and/or carriers 12 and otherwise control the operation of the preferred network 10. The first preferred system or network 10 is not limited to including the controller 20, however, it is preferred that the system or network 10 includes the controller 20 to control, configure and manage the operation of the system or network 10.

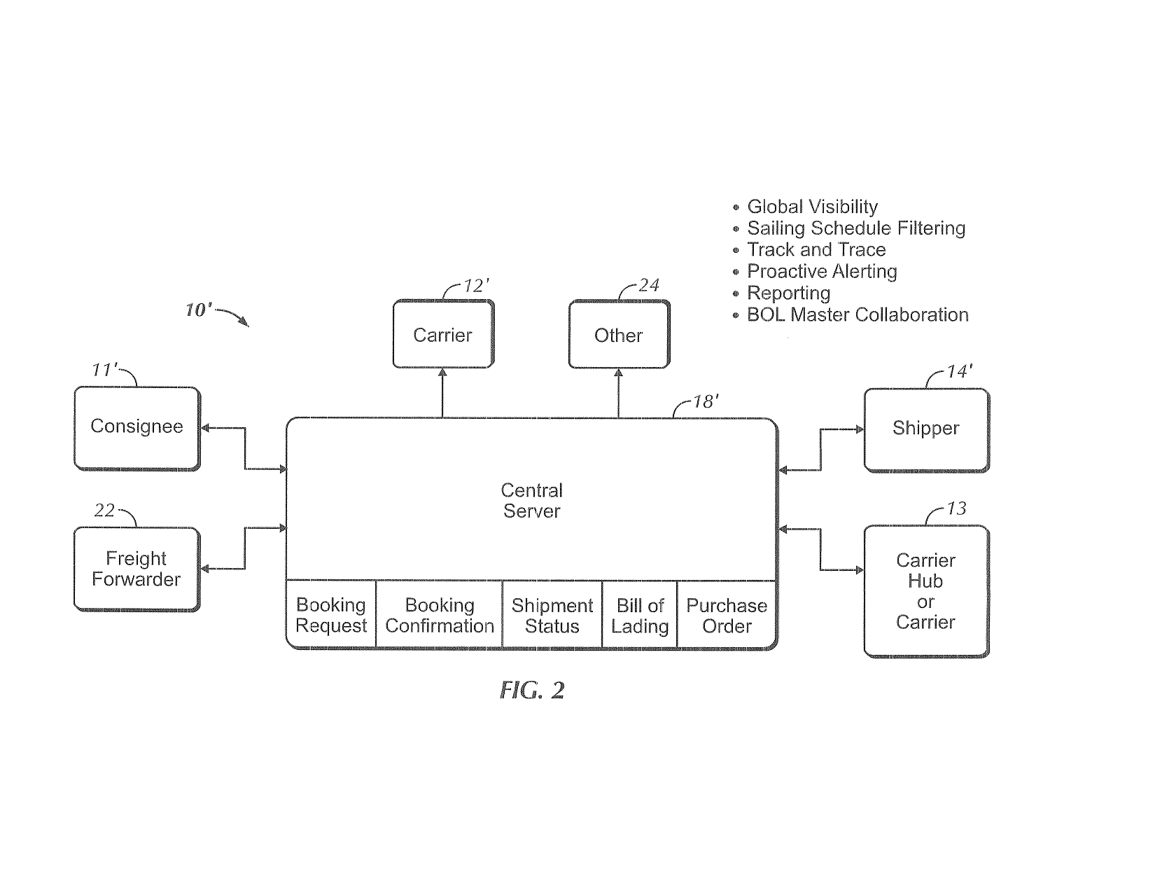

Referring to FIG. 2, a second preferred embodiment of the system or network 10′ includes the central server 18′. The central server 18′ may access for trading members through a portal and/or a hub, but is not so limited. The second preferred embodiment of the system or network 10′ includes similar components to the first preferred system or network 10, therefore, like numerals are utilized to identify like elements with the prime symbol (“′”) used to distinguish the elements of the second preferred embodiment from the first preferred embodiment. In addition to the above-described members 11, 12, 14 of the first preferred network 10, the second preferred network 10′ includes a freight forwarder 22, an other member 24 and a carrier hub or carrier 13, each of which is in communication with the central server 18′. The freight forwarder 22 is generally a person or company that organizes shipments for individuals, the shippers 14, 14′ and/or the consignee 11, 11′. The freight forwarder 22 is generally an expert in working with the carriers 12 or carrier hubs 13 for shipping the freight 16. The freight forwarder 22 is not necessarily included in the second preferred system 10′ but is utilized by certain shippers 14′, consignees 11′ and/or carriers 12′ and carrier hubs 13. The other member 24 may be nearly any other entity that participates in the network, such as a controller, a customs agent or other trading member.

The central server 18′ of the second preferred embodiment may include the portal and the hub, which in combination generally comprise the central server 18′. The portal preferably provides web-based connectivity for the members 11′, 14′, 12′, 13, 22, 24 to the central server 18′ while the hub preferably provides direct connectivity to the members 11′, 12′, 14′, 13, 22, 24. The central server 18′ is not limited to inclusion of the portal and the hub, but such a configuration provides flexibility of connectivity for the members 11′, 12′, 14′, 13, 22, 24 in the system 10′ of the second preferred embodiment. In addition, although the system 10′ of second preferred embodiment does not show capacity for outgoing messages to certain of the members 11′, 12′, 14′, 13, 22, 24 from the hub, transmittal of messages to the members 11′, 12′, 14′, 13, 22, 24 are preferably permitted from both the portal and hub. Generally, once information is stored in the central server 18′ and the specific trading member 11′, 12′, 14′, 13, 22, 24 is authorized to access the information, the particular member 11′, 12′, 14′, 13, 22, 24 may retrieve the information and may also submit information to the central server 18′, which information may either pass through the central server 18′ or may be stored therein for a predetermined amount of time.

Referring to FIGS. 1 and 2, in the operation of the first and second preferred embodiments of the system 10, 10′, the central server 18, 18′ may transmit a shipping bid to the plurality of carriers 12, 12′. The shipping hid may be a bid to ship a specific volume, piece, portion or otherwise of the freight 16 or a general bid to submit particular lanes, routes and capacities that are available by the carrier 12, 12′. In addition, this step of transmitting the shipping bid may be comprised of the central server 18, 18′ mining information previously stored in the central server 18, 18′ regarding rates, lanes, capacities and other restrictions previously submitted by the plurality of carriers 12, 12′.

In response to the shipping bid, the central server 18, 18′ preferably receives a plurality of bid responses from the plurality of carriers 12, 12′. The plurality of bid responses include at least a first bid having a first shipping rate and a first expiration date from a first carrier 12a. The bid responses are not necessarily time limited to being received prior to transmittal of the shipping bid and may be previously stored in the central server 18, 18′, as was described above. In addition, the first bid is not limited to inclusion of exclusively the first shipping rate and the first expiration date and may have additional constraints or limitations depending upon the shipping bid, the constraints of the first carrier 12a or otherwise, as would be apparent to one having ordinary skill in the art.

In the preferred operation, the central server 18, 18′ receives a shipping constraint from the shipper 14, 14′ and/or the consignee 11, 11′. The constraint may be comprised of nearly any constraint or limitation on the shipping of the freight from its point of origin to its destination, such as timing, method of transport, preferred carrier 12, 12′, preferred weigh, volume, pricing or rates, and other like constraints or limitations that would be apparent to one having ordinary skill in the art. In the preferred embodiments, the shipping constraint may include an origin, a destination, a carrier preference for a specific one of the plurality of carriers 12, 12′ and a carrier type, such as land, air, sea or a particular one of the plurality of carriers 12, 12′. The origin may be comprised of a shipper address of a shipper 14, 14′, the destination may be comprised of a consignee address of the consignee 11, 11′, the carrier preference may be comprised of a land carrier, an ocean carrier or an air carrier and the rate limit may be comprised of a maximum shipping rate. When the consignee 11, 11′ is arranging and paying for the shipment of goods, in the preferred embodiment, the consignee 11, 11′ is typically working with a plurality of shippers 14, 14′ through the central server 18, 18′ to obtain various freight 16 and is able to assign constraints to the transactions. These preferred constraints are in no way limiting and the origin, destination, carrier preference and/or rate limit may be otherwise defined as would be apparent to one having ordinary skill in the art. In addition, the constraints, as was described may be arranged and/or set by the shipper 14, 14′, the consignee 11, 11′, the controller 20 or nearly any other member 24 of the trading network who has a reason and/or desire to apply a constraint. Further, the preferred systems 10, 10′ may function and operate without the inclusion of constraints from the shipper 14, 14′, the consignee 11, 11′, the controller 20 and/or nearly any other member 24 of the trading network and may function without constraints, with only predetermined constraints and/or with only constraints defined and applied by specific members of the trading network.

The carrier preference may be comprised of nearly any variety of preference for one of the plurality of carriers 12, 12′ or a constraint to limit the amount, type, value, or related characteristic of the freight 16 that may be transported by one of the plurality of carriers 12, 12′. For example, the carrier preference may be comprised of identifying only the first carrier 12a and a second carrier 12b when the origin is a predetermined country. Accordingly, the carrier preference will permit only the first carrier 12a or the second carrier 12b to ship the specified freight 16 of the shipper 14, 14′ to the predetermined country. The carrier preference may also be weighted to guarantee a predetermined volume of freight 16 to particular carriers 12, 12′, favor certain carriers 12. 12′ by weighting their rates or otherwise preferring or limiting access to certain carriers 12, 12′ in manners that would be understood by one having ordinary skill in the art. For example, the shipping constraint may include a geographic filter favoring local carriers 12, 12′ in a particular jurisdiction or territory, such as a predetermined country.

In the preferred embodiments, once the plurality of hid responses and shipping constraints are received and/or stored in the central server 18, 18′, the central server 18, 18′ determines whether the plurality of responses meet the specific shipping constraints to identify a rejected bid of the plurality of bid responses. The central server 18, 18′ transmits a rejection notification to a rejected carrier of the plurality of carriers 12, 12′ associated with the rejected bid. For example, a third carrier 12c may have submitted a bid response that falls outside the range of the specific shipping constraint. The central server 18, 18′ preferably sends the rejection notification to the third carrier 12c notifying the third carrier 12c that the particular bid response was rejected. The central server 18, 18′ may indicate to the third carrier 12c the reason that the bid was rejected and the third carrier 12c may have an opportunity to modify and re-submit the bid. Alternatively, the bid may be indicated as finally rejected in the rejection notification to the third carrier 12c and no opportunity for modification may be provided and no reasoning for the rejection is required.

The central server 18, 18′ is also preferably able to determine whether the plurality of bid responses meet the shipping constraint to identify a plurality of accepted bids of the plurality of bid responses. The central server 18, 18′ transmits a plurality of acceptance notifications to a plurality of accepted carriers of plurality of carriers 12, 12′. In the preferred embodiments, the plurality of accepted bids include at least the first bid. For example, the first carrier 12a may submit the first bid, which meets each of the shipping constraints and the central server 18, 18′ transmits an acceptance notification to the first carrier 12a. In addition, the second carrier 12b may transmit a second bid that meets all of the shipping constraints and the central server 18, 18′ will also transmit an acceptance notification to the second carrier 12b. The second bid preferably has a second shipping rate and a second expiration date. The first and second bids may comprise the plurality of accepted bids or additional bids may be received that meet the shipping constraints and also comprise accepted bids.

In the preferred embodiments, the shipping constraint may include at least an origin and a destination. The central server 18, 18′ may send a signal to display stored rate information to the shipper 14, 14′ or the consignee 11, 11′ stored rate information that satisfies the shipping constraint. The shipper 14, 14′ and/or consignee 11, 11′ may then select one of the bids that meets the shipping constraints for the particular job. Once selected, the central server 18, 18′ preferably transmits an acceptance to the elected carrier of the preferred carriers 12, 12′, which automatically initiates the shipment and, preferably, tracking of the shipment by the central server 18, 18′.

When the accepted bids have been identified, the accepted bids are preferably stored at the central server 18, 18′. The plurality of accepted bids are preferably stored until at least their respective expiration dates. The stored accepted bids may then be searched by the central server 18, 18′ if an when additional shipping bids and constraints are received by the central server 18, 18′ to determine if any of the accepted bids meet the relevant shipping bids and the related constraints.

The consignee 11, 11′ or shipper 14, 14′ preferably considers the plurality of accepted bids and selects one of the accepted bids as a selected bid. The selected bid is received by the central server 18, 18′ and is comprised of the first bid in the preferred embodiment. The central server 18, 18′ preferably transmits a booking request to the first carrier 12a as a result of the first bid being the selected bid. Based on the booking request, the first carrier 12a commences shipment of the freight 16 to the consignee 11, 11′. The central server 18, 18′ preferably receives at least a ship date when the freight 16 is received by the first carrier 12a, 12a′ and a receipt date that the freight 16 is delivered to the consignee 11, 11′ at the destination of the freight 16. The central server 18, 18′ may also receive additional tracking or shipment status information as the freight 16 is shipped from its point of origin to the consignee 11, 11′ or its destination. For example, the plurality of carriers 12, 12′ may include a land carrier and an ocean carrier. The ship date may be comprised of a land ship date when the freight 16 is received by the land carrier, an ocean receipt date when the freight 16 is delivered to the ocean carrier by the land carrier and additional shipment information as the freight 16 moves from its point of origin to its point of destination. The first carrier 12a may be comprised of the land carrier and the ocean carrier and nearly any number of physical carriers that it takes to move the freight 16 from its point of origin to its point of destination.

The central server 18, 18′ preferably stores the first bid, which is the selected bid, the ship date and the receipt date, at least until the first expiration date of the first bid. The central server 18, 18′ preferably stores all of the information submitted by the trading members 11, 11′, 12, 12′, 14, 14′, 20, 20′, which information may be mined, categorized and analyzed by the particular trading members 11, 11′, 12, 12′, 14, 14′, 20.

Information that may be stored and manipulated by the central server 18, 18′ preferably includes a volume of freight shipped by at least the first carrier 12a or nearly any of the carriers 12, 12′. For example, the volume or total volume of freight shipped by the first carrier 12a, the second carrier 12b, the third carrier 12c, a fourth carrier 12n and a fifth carrier (not shown) for the shipper 14 may be stored by the central server 18, 18′. The central server 18, 18′ may determine a listing of top five carriers 12, 12′ by volume for the particular shipper 14, 14′ or the consignee 11, 11′ such that the shipper 14, 14′ and/or consignee 11, 11′ may make decisions regarding shipment of the freight 16 based upon these statistics and calculations made by the central server 18, 18′. The central server 18, 18′ is not limited to determining the top five carriers 12, 12′ by volume but may track, manipulate, calculate or otherwise monitor the information transmitted to the central server 18, 18′ for the benefit of the trading members 11, 11′, 14, 14′, 12, 12′. For example, the central server 18, 18′ may specifically track projected and actual shipping and receipt dates of the carriers 12, 12′ to determine an on-time rate of the specific carriers 12, 12′. Further, the central server 18, 18′ may send signals to the trading members 11, 11′, 14, 14′, 12, 12′ of active events or jobs, wherein the freight 16 is in route between its point of origin and its destination, such that the trading members 11, 11′, 12, 12′, 14, 14′ can actively review and track the freight 16, 16′. The freight 16, 16′ may be passively tracked by the trading members 11, 11′, 14, 14′, 12, 12′ by transmission of information manually to the central server 18, 18′ during the various stages of the shipment or the freight 16 may be actively monitored by tracking sensors that automatically send signals to the carriers 12, 12′. The carriers 12, 12′ then preferably transmit the status information to the central server 18, 18′. The freight 16 may alternatively be actively monitored by tracking sensors that automatically send signals to the central server 18, 18′ regarding status information of the freight 16, such as its geographic location. The status information of the freight 16 can then be conveyed to the trading members 11, 11′, 12, 12′, 14, 14′ and/or the controller 20.

Referring to FIG. 2, in the second preferred embodiment of the system 10′, a preferred method may include the carrier 12′ and carrier hub 13 transmitting sailing or shipment schedules to the central server 18′ and the central server 18′ receiving the sailing or shipping schedules. The consignee 11′ may then submit a purchase order to the central server 18′. Sailing and/or shipping schedules that meet the constraints of the purchase order are presented to the consignee 11′ and the consignee 11′ selects a bid that corresponds with one of the sailing or shipping schedules from the carriers 12′ or carrier hub 13. The selected bid is presented to the appropriate freight forwarder 22 and a booking request is transmitted from the freight forwarder 22 to the central server 18′, which receives the booking request. The selected carrier 12′ or carrier hub 13 generates a booking confirmation that is received by the central server 18′ and shipping instructions are also generated. A Bill of Lading is also preferably created and communicated with the shipper 14′. The Bill of

Lading is a document generally issued by the carrier 12′ which details a shipment of the freight 16 and gives title of the shipment to a selected member of the network 11′, 12′, 14′, 13, 22 or otherwise. The Bill of Lading may also define other elements of the shipment that would be apparent to one having ordinary skill in the art and will not be described in further detail herein. A shipment status of the freight 16 is subsequently received by the central server 18′, either by manual insertions by members of the trading network 11′, 12′, 14′, 13, 22 or automatically via sensors. The freight 16 is preferably tracked from its point of origin to its destination by the carriers 12′ and the relevant information is received by and stored in the central server 18′. The preferred system 10′ of the second preferred embodiment provides global visibility, sailing schedule filtering, track and trace of the freight 16, proactive altering of the shipment as may be required, reporting and Bill of Lading master collaboration.

The shipping instructions of the second preferred embodiment may come or preferably come from the trading member 11′, 12′, 14′, 13, 22 that loads the freight 16 into the shipping container. The trading member 11′, 12′, 14′, 13, 22 that loads the freight 16 may be the carrier 12′, the carrier hub 13, the freight forwarder 22 or any other trading member. Upon loading into the container, the freight 16 is preferably provided with a container number and description of goods that is received by and stored in the central server 18′. This process described for the second preferred system or network 10′ is not limiting and the flow of information and/or freight 16 may vary depending upon how the trading members 11, 11′, 12, 12′, 14, 14′, 13, 22 and/or the controller 20 design and configure the particular trading and/or shipping event and each event may be configured and or designed in a different manner, as would be apparent to one having ordinary skill in the art.

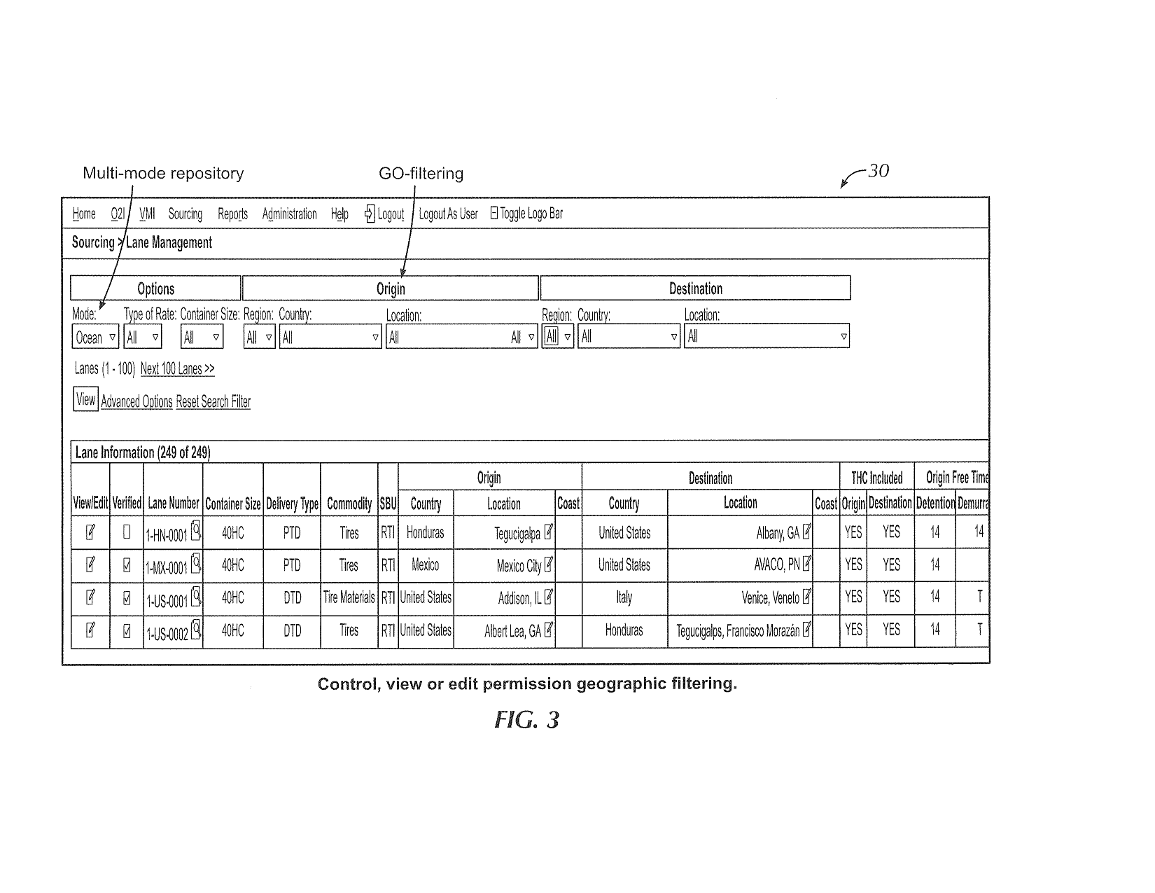

Referring to FIG. 3, the central servers 18, 18′ of the preferred systems 10, 10′ are preferably able to display or transmit signals to hardware to display various Graphical User Interfaces (”GUI″) that permit the trading members, including the shipper 14, 14′, the consignee 11, 11′, the carriers 12, 12′, the controller 20 and any additional members who have access to the preferred networks 10, 10′ through the central server 18, 18′, to interact with the systems 10, 10′. The preferred GUIs allow the users 11, 11′, 14, 14′, 12, 20 to interact with the central server 18, 18′ and organize and review the information that they have access to in the central server 18, 18′. The trading members 11, 11′, 12, 14, 14′, 20 may utilize nearly any variety of device to communicate with the central server 18, 18′, including desktop computers, laptops, handheld devices or nearly any other device that permits display of the GUIs and communication with the central server 18, 18′.

The users or trading members 11, 11′, 12, 14, 14′, 20 are preferably granted access to their own and related information on the central server 18, 18′, but not all information stored at the central server 18, 18′, particularly the information of other trading members 11, 11′, 12, 12′, 14, 14′, 20. To facilitate this limited access, the trading members 11, 11′, 12, 14, 14′, 20 are preferably required to provide login information, such as a user name and password, to gain access to the central server 18, 18′, which thereby permits the central server 18, 18′ to limit access to the relevant information.

FIG. 3 is specifically directed to a lane management GUI 30 that is preferably displayed to the shipper 14, 14′ or the consignee 11, 11′. Preferably, the trading member that is paying the carrier 12, 12′ is the entity that is able to gain access to the lane management GUI 30. The shipper 14 14′ or consignee 11, 11′ preferably utilizes this preferred lane management GUI 30 for setting up shipping lanes. The preferred lane management GUI 30 may be modified to show ocean lanes, which is the view shown in FIG. 3, air transport, ground transport or any other variety of transport that may be applicable. The information may also be filtered by type of rate, container size, region, country, location and whether the location is an origin or destination. Multiple varieties of information related to each shipment may also be included, such as view/edit, verified, lane number, container size, delivery type, commodity, SBU, origin country, origin location, origin coast, destination country, destination location, destination coast, THC included origin, THC included destination, origin free time and nearly any other related information that may be relevant to the particular freight or job. The preferred lane management GUI 30 preferably permits control, viewing and/or edit permission for geographic filtering.

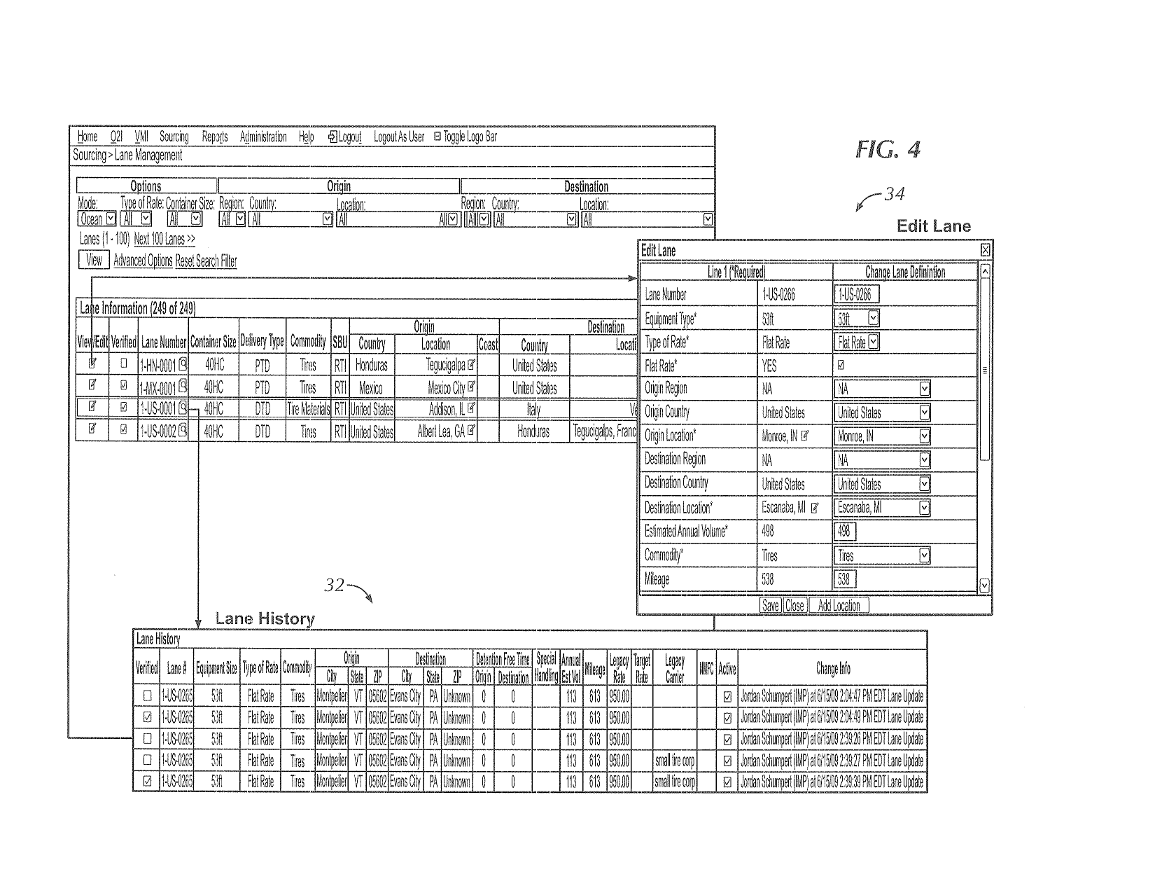

Referring to FIG. 4, the lane management GUI 30 of FIG. 3 is shown with an edit lane GUI 32 and a lane history GUI 34. The lane history GUI 34 preferably shows all changes made to lanes while in the preferred system 10, 10′. The trading member, preferably the shipper 14, 14′ or the consignee 11, 11′, may edit the lane number, equipment type, type of rate, whether the rate is flat, origin region, origin country, origin location, destination region, destination country, destination location, estimated annual volume, commodity, mileage and nearly any other element or factor that may be relevant to the particular lane. The lane management GUI is not limited to the functionality, appearance or type and variety of information included and may be modifiable and have an appearance different than that shown in FIGS. 3 and 4.

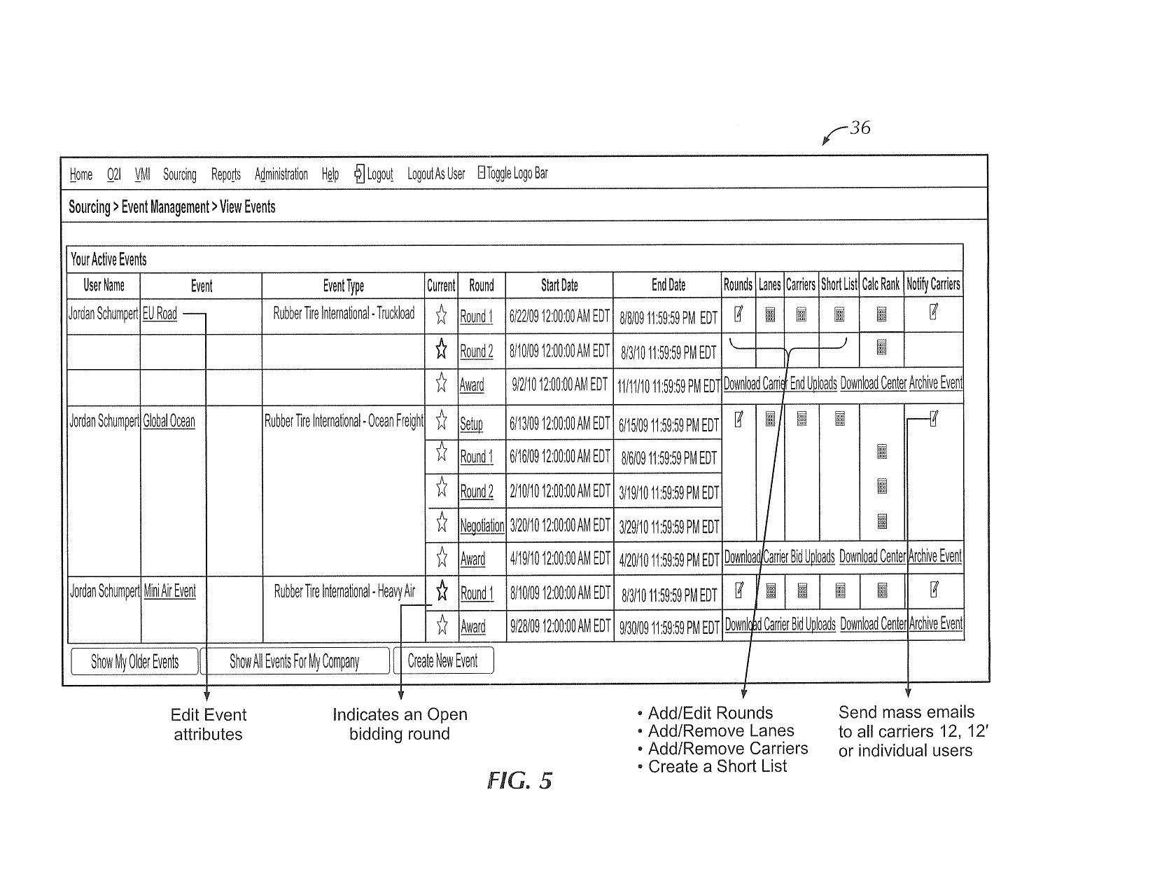

Referring to FIG. 5, a consignee view events GUI 36, which is preferably a GUI for the consignee 11, 11′, provides the ability to edit existing events and event attributes such as rounds, lanes, carriers, short listing and carrier notification. The consignee view events GUI 36 preferably lists a username, an event or event name, an event type, whether the event is current, the particular round of the event, a start date, an end date, whether there will be rounds in the event, lanes, carriers, short list, rank calculation and a carrier notification feature. These features and elements are not meant to be limiting and the consignee view events GUI 36 may be otherwise configured and include additional or less features as may be preferred by the user. The consignee view events GUI 36 preferably includes the notify carrier feature to permit mass emails to all of the plurality of carriers 12 or individual users of the network 12, 14, 14′, 12′, 20 to submit messages related to the particular event. The current column in the view events GUI 36 preferably indicates to the user whether the event is in an open or closed bidding round. The event column preferably permits editing of event attributes by selecting the particular event and displaying a subsequent pop-up that permits editing of the event attributes.

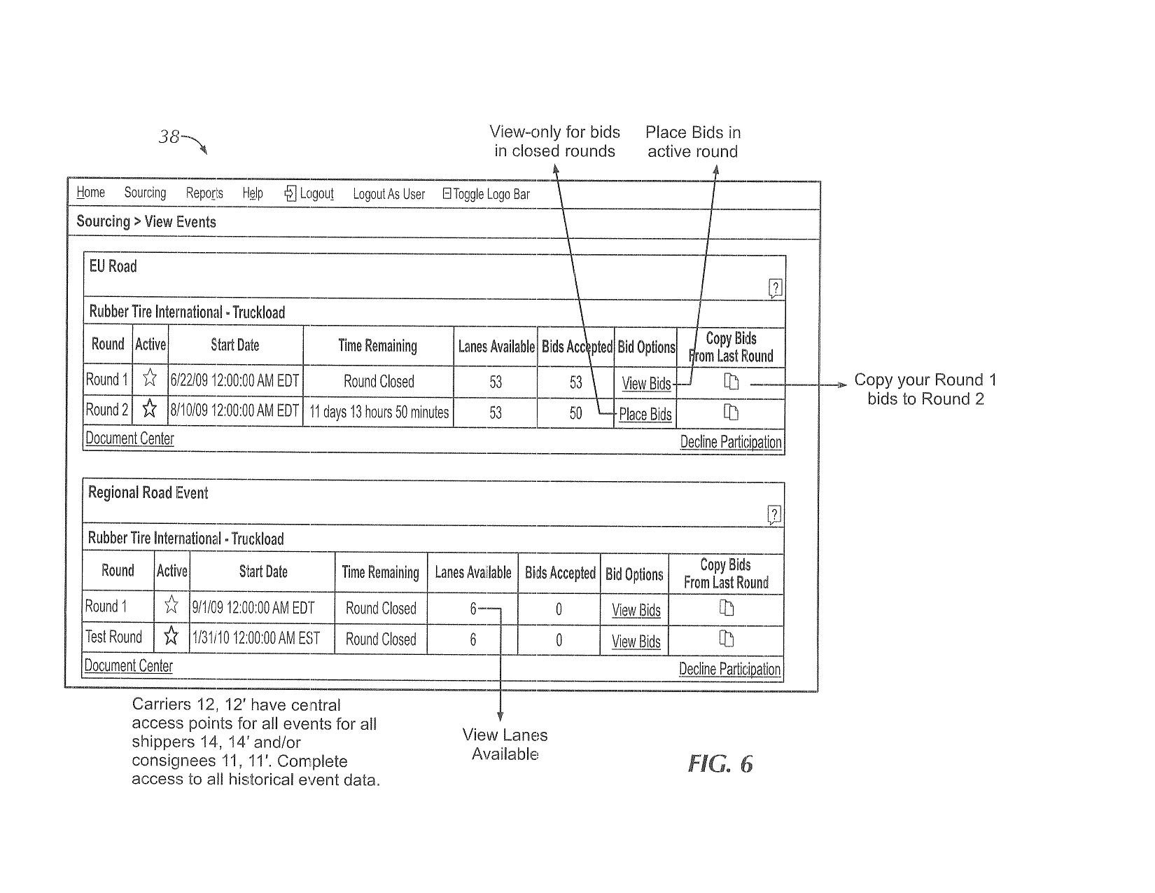

Referring to FIG. 6, a carrier's view events GUI 38 shows the ability to view previous bids, place new bids, copy bids from previous rounds and manage participation in an event, which is preferably viewable by the plurality of carriers 12, 12′. The plurality of carriers 12, 12′ preferably have central access points for all events for all consignees and shippers 11, 11′, 14, 14′, but may alternatively be limited in the information that they are able to view. In addition, the carriers 12, 12′ preferably have complete access to all historical event data or at least historical event data associated with the particular one of the carriers 12, 12′. The carriers 12, 12′ are also preferably able to search and organize events and bids in various manners for example, as shown in FIGS. 6 to display EU road event or regional road events. The carrier's view events GUI 38 also preferably enables view only in closed rounds, placing of bids in open or active rounds, copying of bids from previous rounds to subsequent rounds, modification of bids and other options as would be apparent to one having ordinary skill in the art based upon a review of the present disclosure and FIG. 6.

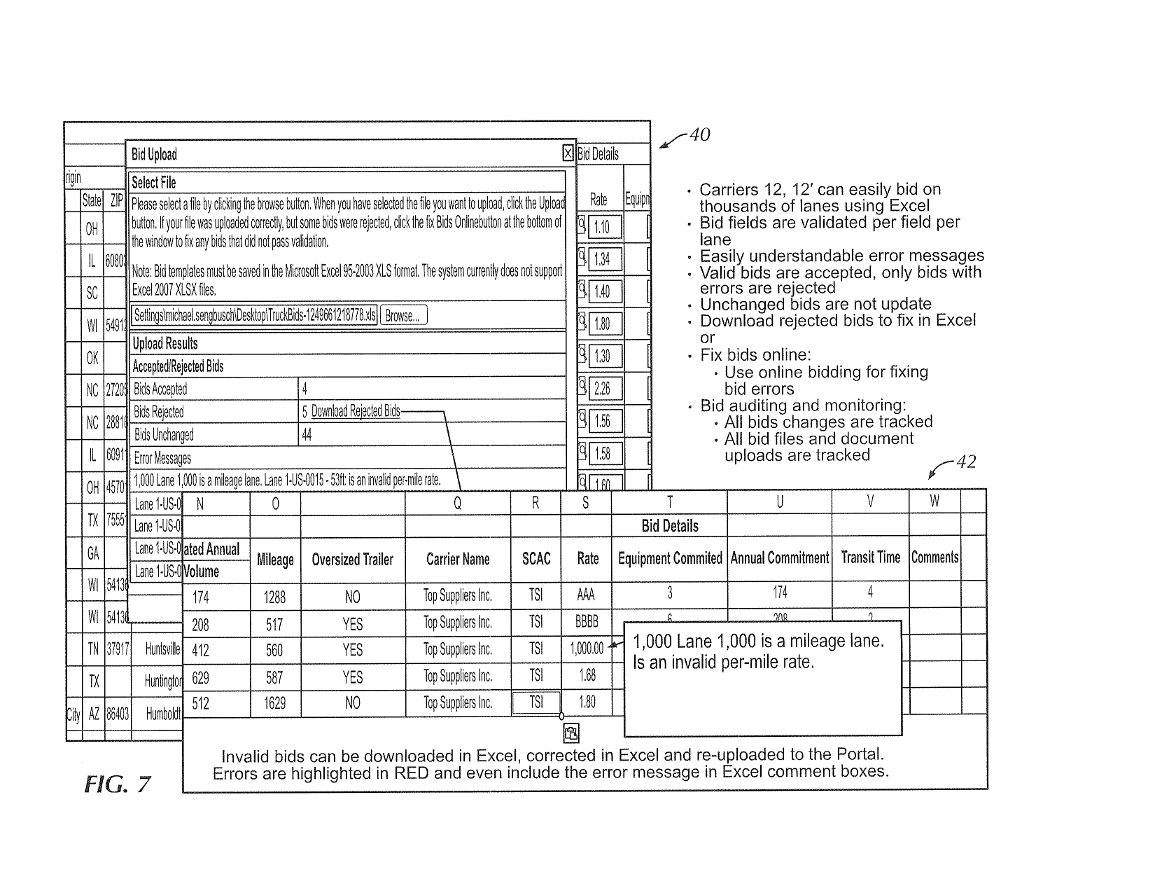

Referring to FIG. 7, the carriers 12 preferably have the ability to bulk upload bids to the central server 18, 18′ to simplify the submission of bids, preferably utilizing a bid upload GUI 40.

The controller 20 preferably sets up bid rules and the central server 18, 18′ is preferably able to filter bulk uploaded bids to indicate to the carriers 12, 12′ invalid bids that are submitted and provide a warning or other output to the carriers 12, 12′ related to the invalid bids. The carriers 12, 12′ are preferably able to edit the invalid bids to bring them into compliance with the bid rules. The bulk download bids permits easy bidding on thousands of lanes using spreadsheets or other configurations, permits bid fields to be validated per field and/or per lane based on bid rules set up by the controller 20, provides easily understandable error messages related to invalid bids, quickly and easily accepts valid bids resulting in only bids with errors being identified as invalid bids, maintains unchanged bids, permits download of rejected or invalid bids for fixing or editing in a spreadsheet or other format, permits fixing of invalid or rejected bids using online bidding for fixing the errors and permits bid auditing and monitoring by tracking bid changes and documenting and tracking bid uploads of the carrier 12, 12′. Invalid bid may also be downloaded, corrected and/or re-loaded to the central server 18, 18′, preferably utilizing a download rejected bids pop-up GUI 42. Errors are preferably highlighted in red and may include an error message to quickly identify the reason that the particular bid was invalidated by the central server 18, 18′.

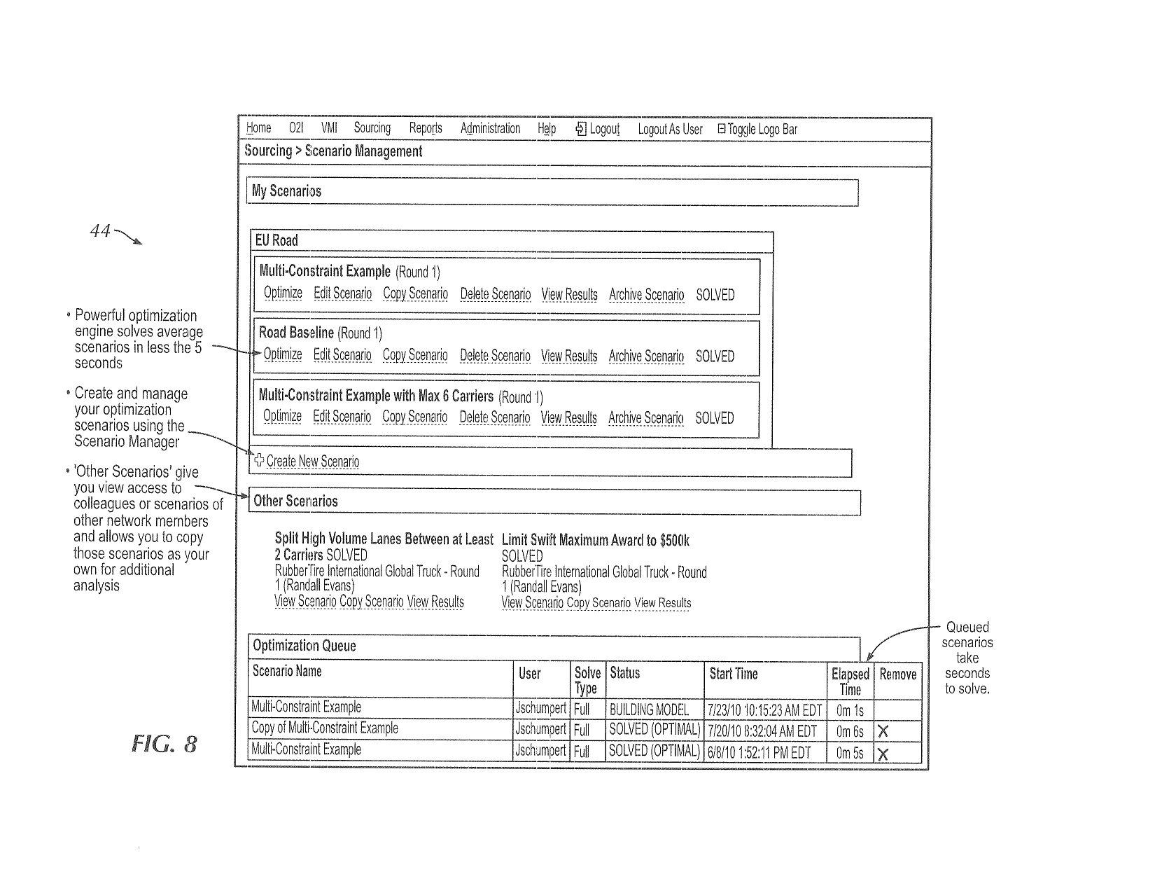

Referring to FIG. 8, a scenario management GUI 44 of the preferred system 10, 10′ allows the consignee 11, 11′ to create customized scenarios tailored to their business needs. The consignee 11, 11′ is preferably able to create constraints, run optimizations, view optimization results and conduct other related functions. The central server 18, 18′ preferably, quickly solves various scenarios. The central server 18, 18′ is also preferably able to create other scenarios that give the consignee 11, 11′ access to scenarios of colleagues, scenarios created by the central server 18, 18′, scenarios created by the controller 20, 20′ and/or allows the consignees 11, 11′ to copy the scenarios as their own for addition analysis. Accordingly, the preferred system 10, 10′ is able to propose the other or alternative scenarios to assist in optimizing the event. The consignee 11, 11′ and/or shipper 14 14′ are also able to create their own custom events and/or rules for their own events.

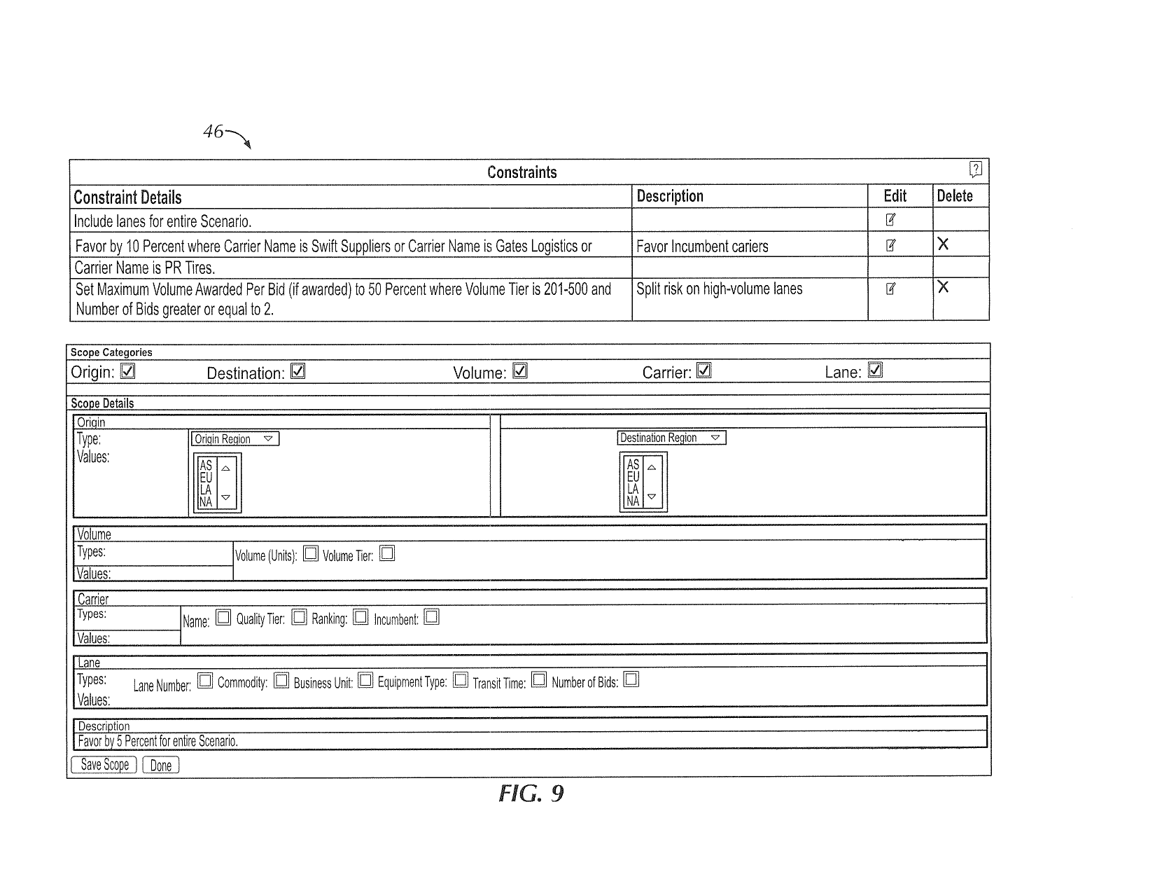

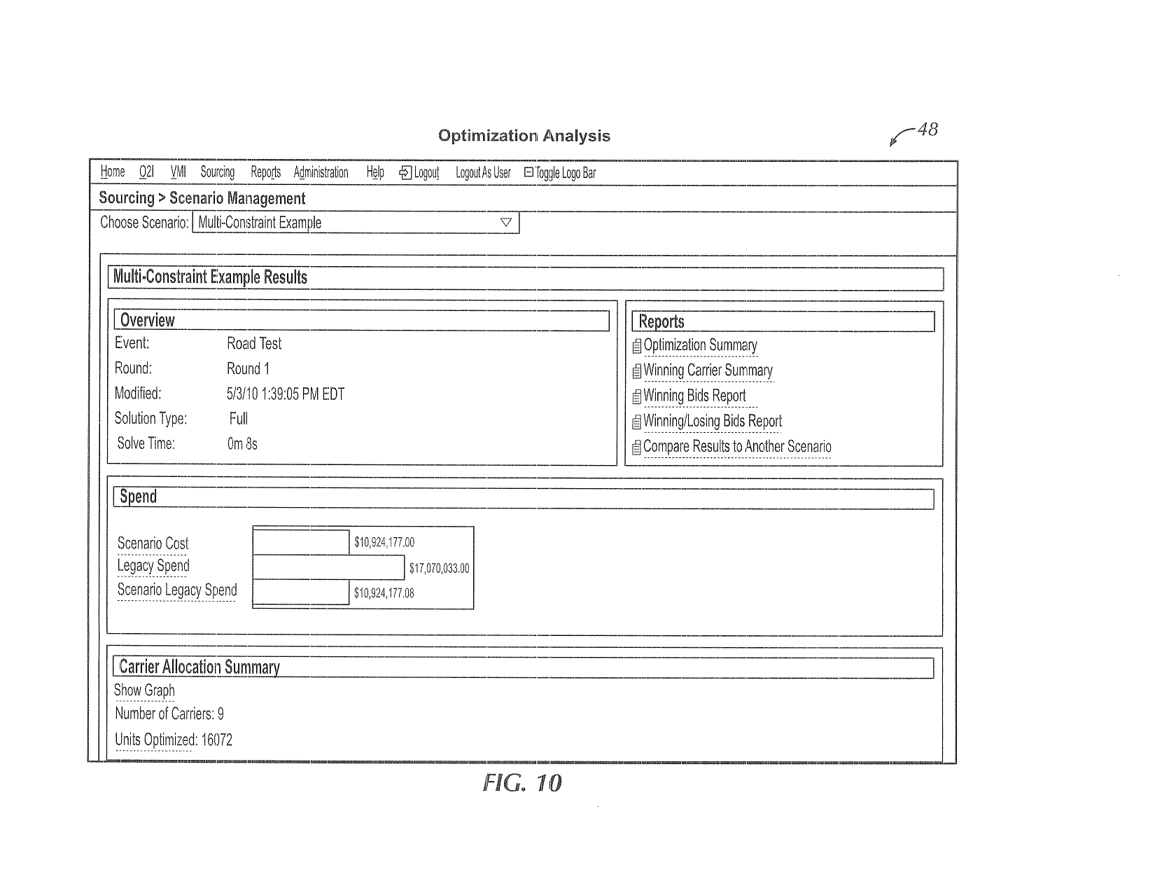

Referring to FIGS. 9 and 10, a constraints GUI 46 preferably permits customizing and managing constraints for individual scenarios and/or events. The shipper 14, 14′ and/or consignee 11, 11′ are preferably able to customize scenarios based on origin, destination, volume, carrier, lane and/or other related constraints or elements of information related to the supply chain. The central server 18, 18′ is preferably able to provide example results of the customized constraint scenarios and provide reports related to optimization, a winning carrier, a winning bid, a winning/losing bid and a comparison of results to other scenarios. The central server 18, 18′ also preferably is able to estimate costs for the customized scenarios and provide a carrier allocation, with a potential graphical or visual indication of allocation. A scenario management or optimization analysis GUI 48 is a preferred set of results from an optimized scenario and is specific to the constraints defined by that scenario. The preferred optimization analysis GUI 48 shows at least total cost, carrier summary and bid reports.

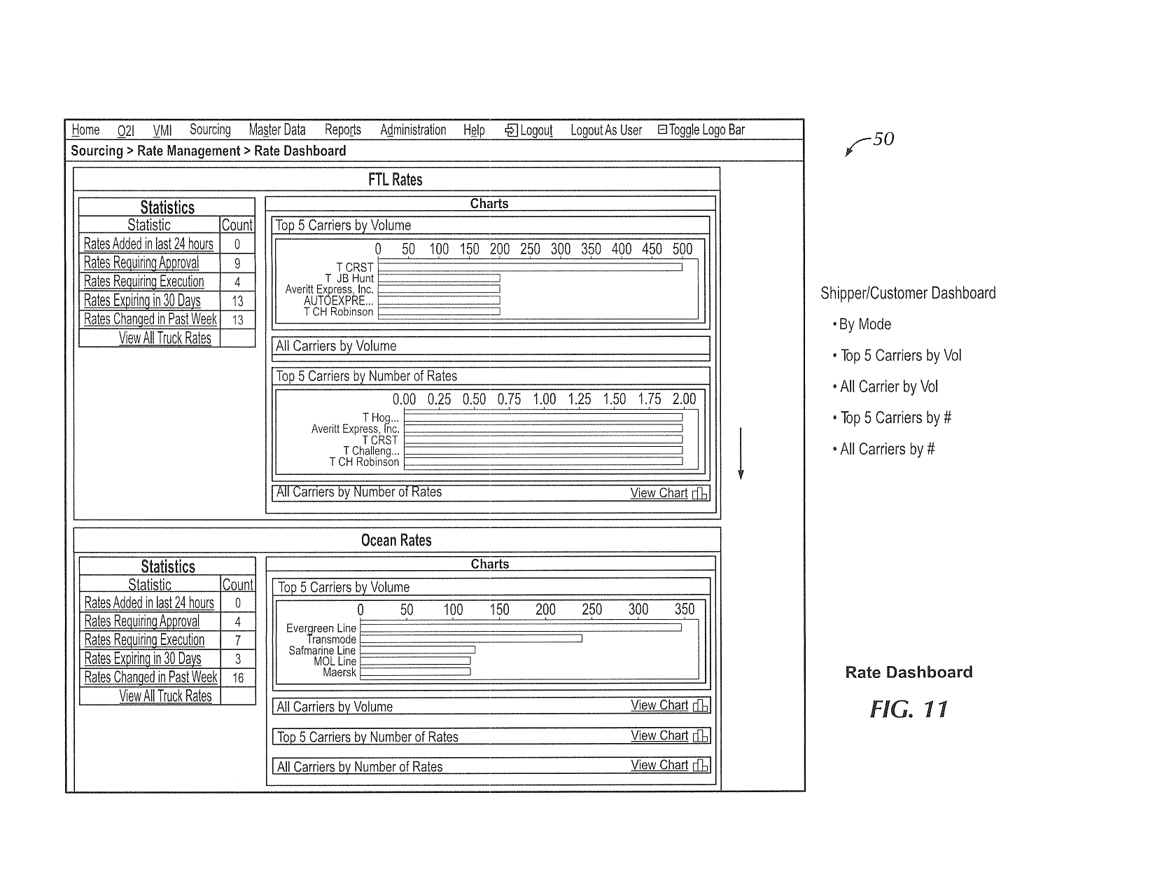

Referring to FIG. 11, a rate dashboard GUI 50 is preferably used to keep track of the plurality of carriers 12, 12′, rates added in a particular time period, such as the last twenty four (24) hours, rates requiring approval, rates requiring execution, rates expiring in a predetermined amount of time, such as thirty (30) days and rates changed in a particular amount of time, such as during the past week. The rate dashboard is preferably able to be filtered by mode of transportation, top carriers by volume, all carriers by volume, top carriers by number, all carriers by number or other related information for ranking or filtering the carriers 12, 12′. The rate dashboard 50 may alternatively be referred to as a consignee dashboard and/or a shipper dashboard 50.

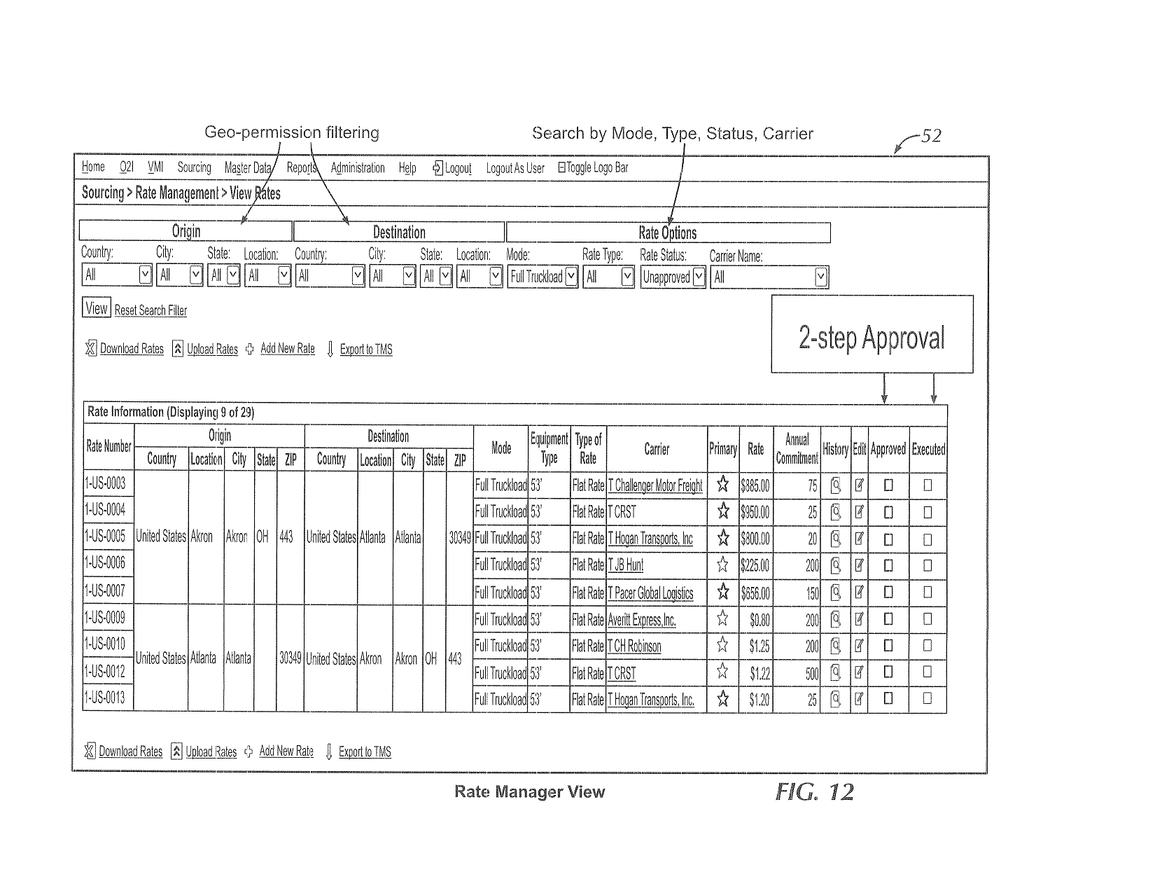

Referring to FIG. 12, a rate management GUI 52 of the preferred systems 10, 10′ is preferably used for approving and executing on rates. The rate management GUI 52 preferably has an appearance and function similar to the lane management GUI 30 as far as column headers and searching capabilities. In addition, a rate number is preferably generated for each rate loaded into the rate management GUI 52. The information also preferably includes the carrier 12, 12′, the carriers rate and annual commitment to the carriers 12, 12′, along with a history and edit option. The rate management GUI 52 may also be filtered by several elements, based upon the desires of the user, the rules employed by the controller 20 or other factors, as would be understood by one having ordinary skill in the art.

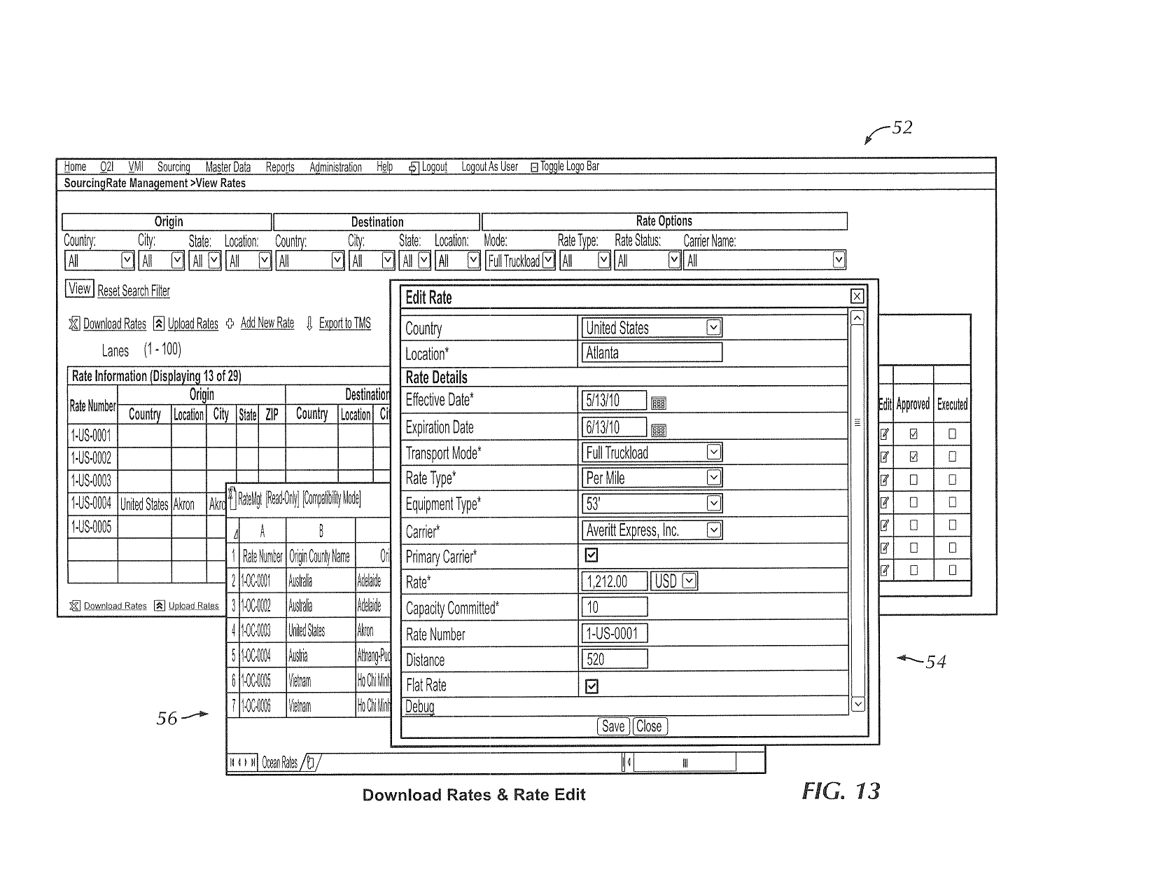

Referring to FIG. 13, the rate management GUI 52 may be used to add new rates and/or edit rates, preferably utilizing an edit rate pop-up GUI 54, download rates, preferably utilizing a pop-up download rates GUI 56 and/or upload rates via spread sheet or other mechanism. Numerous fields may be utilized to edit the rates and effective expiration dates may be manipulated in the preferred systems 10, 10′.

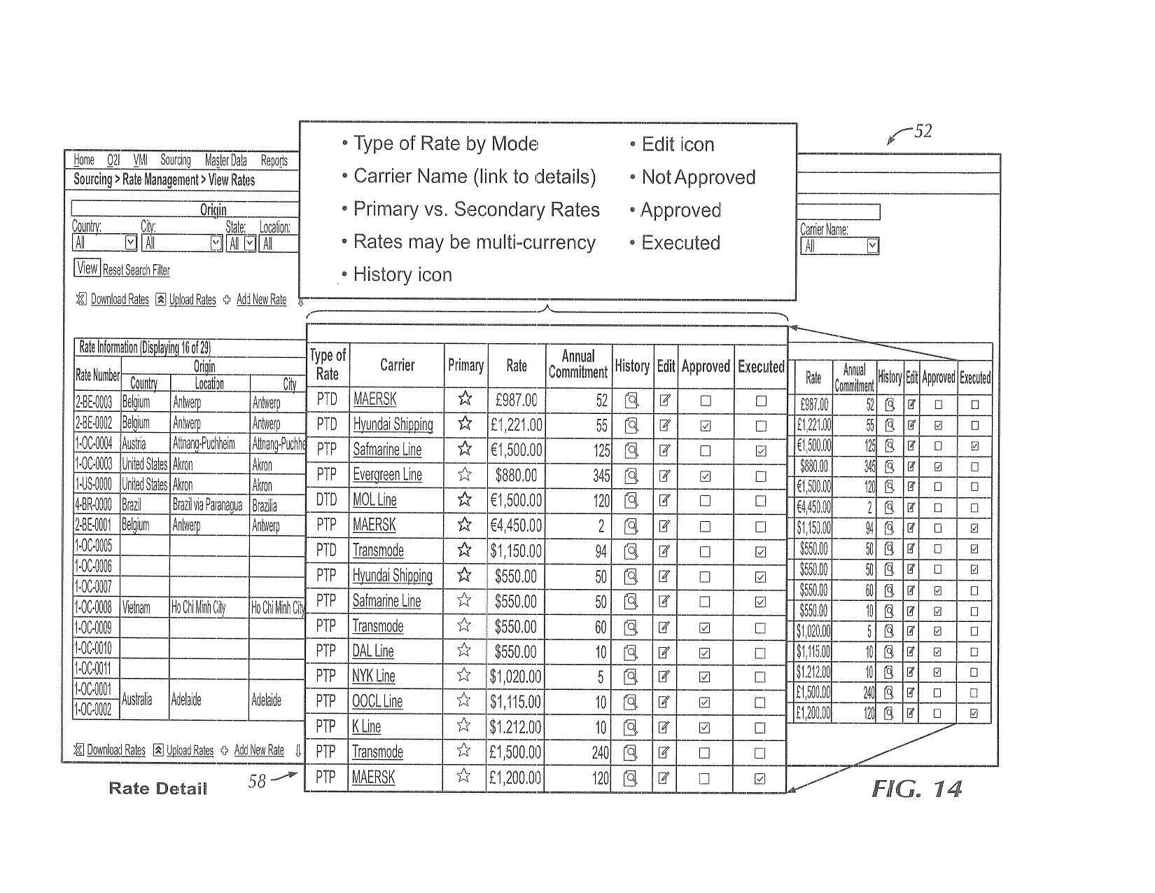

Referring to FIG. 14, the rate management GUI 52 is also preferably able to show the main attributes of rates, preferably via a main attributed pop-up GUI 58. The main attributes preferably include type of rate by mode, carrier name, primary vs. secondary rates, history, an edit option, approved designation, not approved designation and an executed designation. The preferred rates may be listed in multiple currency and may be modified between different currency based on user preferences.

The preferred system 10, 10′ is able to support high volume events with significant monetary value, such as more than five hundred million dollars ($500,000,000) in spend, hundreds of carriers 12, 12′, significant numbers of lanes, such as ten thousand (10,000) or more and significant numbers of bids per round, such as at least one hundred thousand (100,000) bids. The preferred systems 10, 10′ are also preferably able to support a global network of trade members in all areas of the globe including North America, South America, Europe and Asia. In addition, the preferred systems 10, 10′ are able to operate in and translate between any language, but at least nine (9) different languages are fully translatable.

The preferred systems 10, 10′ also include a logistic management suite. The logistic management suite is preferably utilized for transportation, customer service and purchasing organizations. The logistics management suite is preferably able to drive inventory management, enable on-time carriage at the lowest possible cost, provide real-time or near real-time shipment visibility, enforce contract compliance, lower detention and/or demurrage cost and optimize loading dock and terminal resources. Particularly, for road events, the logistics management suite provides for carrier booking and visibility and slot booking and optimization. The logistics management suite of the preferred embodiments also provides an ocean events carrier booking invisibility, direct sailing schedule integration, bill of lading (“BOL”) collaboration and sea weight bills. The logistics management suite also preferably provides rate management, terminal and warehouse information and global supply management.

The preferred systems 10, 10′ in ocean transport events or scenarios are preferably able to establish connectivity between the controller 20, freight forwarder 22 and carriers 12, 12′, particularly the ocean carriers 12, 12′, to provide an integrated platform for overseas supply chain to improve visibility and ultimately to aid in reducing working capital through a reduction in inventory, the number of emergency shipments, as well as a reduction in detention and demurrage costs. The preferred systems 10, 10′ connect all stakeholders, facilitate automatic collaboration on BOL master, increase productivity by streamlining communication and provide proactive notifications and alerts, thereby reducing the emergency shipments and reducing the tension/demurrage. These features benefit carriers 12, 12′ and/or consignees 11, 11′ who are paying for a cost, freight forwarders 22 who need connectivity and process automation and all members of the trading network to improve visibility of the entire shipping process.

The preferred systems 10, 10′ offer ocean freight scheduling, booking, visibility and logistic documentation services. The preferred systems 10, 10′ can be used as a stand alone logistics module or can be bundled with existing procurement processes and functionalities to implement a comprehensive supply chain platform that provides consignees 11, 11′, shippers 14, 14′, buyers and carriers 12, 12′ with visibility into overseas procurement and goods or freight 16 movement. The preferred systems 10, 10′ provide for ocean freight scheduling, ocean freight booking, BOL master collaboration, shipment event management, purchase order management, trading partner connectivity, software as a service-based (“SaaS-based”) technologies, multi-tenant technologies and multi-language use. The freight 16 may be nearly any type and/or variety of goods that the shipper 14, 14′, consignee 11, 11′ and/or other network member 24 may desire to have shipped. The preferred freight 16 may be comprised of bulk chemicals, tires, tire materials, packaged chemicals such as pallets and/or drums and like materials and freight.

The systems 10, 10′ of the preferred embodiments permit access to sailing schedule data via direct access to the central server 18, 18′. Purchase orders that are received by the central server 18, 18′ are preferably integrated with the freight forwarders 22 to initiate an automated booking process. The automated booking process is preferably designed and configured by the controller 20 such that the process occurs automatically upon receipt of the purchase order at the central server 18, 18′. Booking requests are preferably sent by the freight forwarder 22 to the carrier 12, 12′ to request space on a specific vehicle, vessel, voyage or related transport. The central server 18, 18′ preferably transmits or sends booking, confirmations that may be received from the carrier 12, 12′ to indicate whether a booking request was accepted or needs to be adjusted. The preferred shipping instructions are created by the shipper and sent to the carrier 12, 12′, instructing them how to print the BOL. The shipping instructions may be negotiated online via a BOL collaboration model within the central server 18, 18′. Status of shipments are preferably provided real-time based upon status receipts from the carriers 12, 12′ or carrier hubs 13 based on purchase orders, BOL's or container numbers. The central server 18, 18′ may alternately, automatically provide notification and proactive alerts based on the receipt of signals from a sensor carried by, associated with and/or attached to the freight 16. The central server 18, 18′ is also preferably able to create ocean order reports that provide a single interface linking overseas purchase orders to their respective transport signals including bookings, shipping instructions and equipment statuses.

The preferred systems 10, 10′ also include a sailing schedules search GUI 60 that permits lookup and viewing of sailing schedules and events. The sailing schedules may be filtered by point of interest, port of interest, departure, arrival, date ranges, carrier and other related information of the sailing schedules. The sailing schedule search may also be utilized to select a particular schedule and choose to book the event or lane. Access to the sailing schedules lookup may be provided through the portal and/or the hub. The sailing schedules search permits a single platform for connection to the carriers 12, 12′.

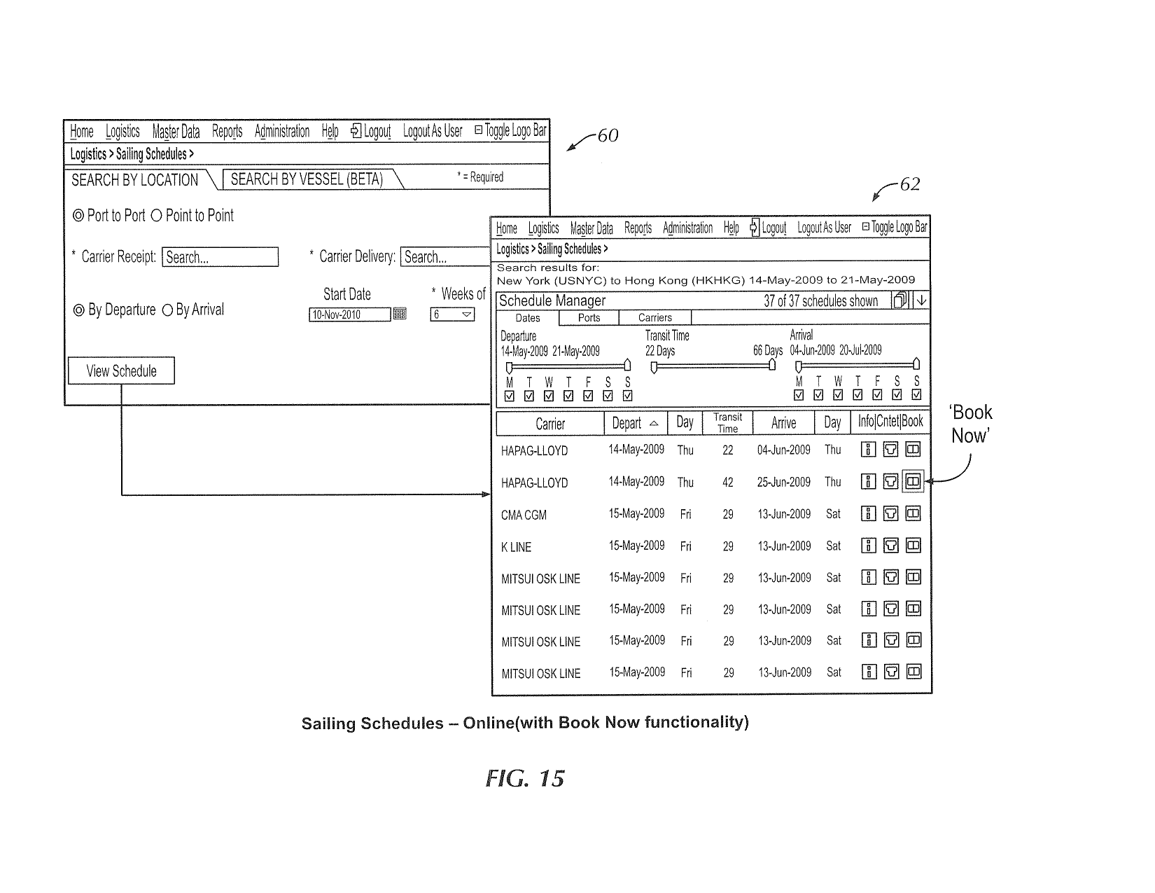

Referring to FIG. 15, the sailing schedules search GUI 60 and a view schedules GUI 62 is shown. The view schedules GUI 62 preferably includes a “book now” option that permits immediate booking on the scheduled sailing or a specific amount of space on the scheduled sailing.

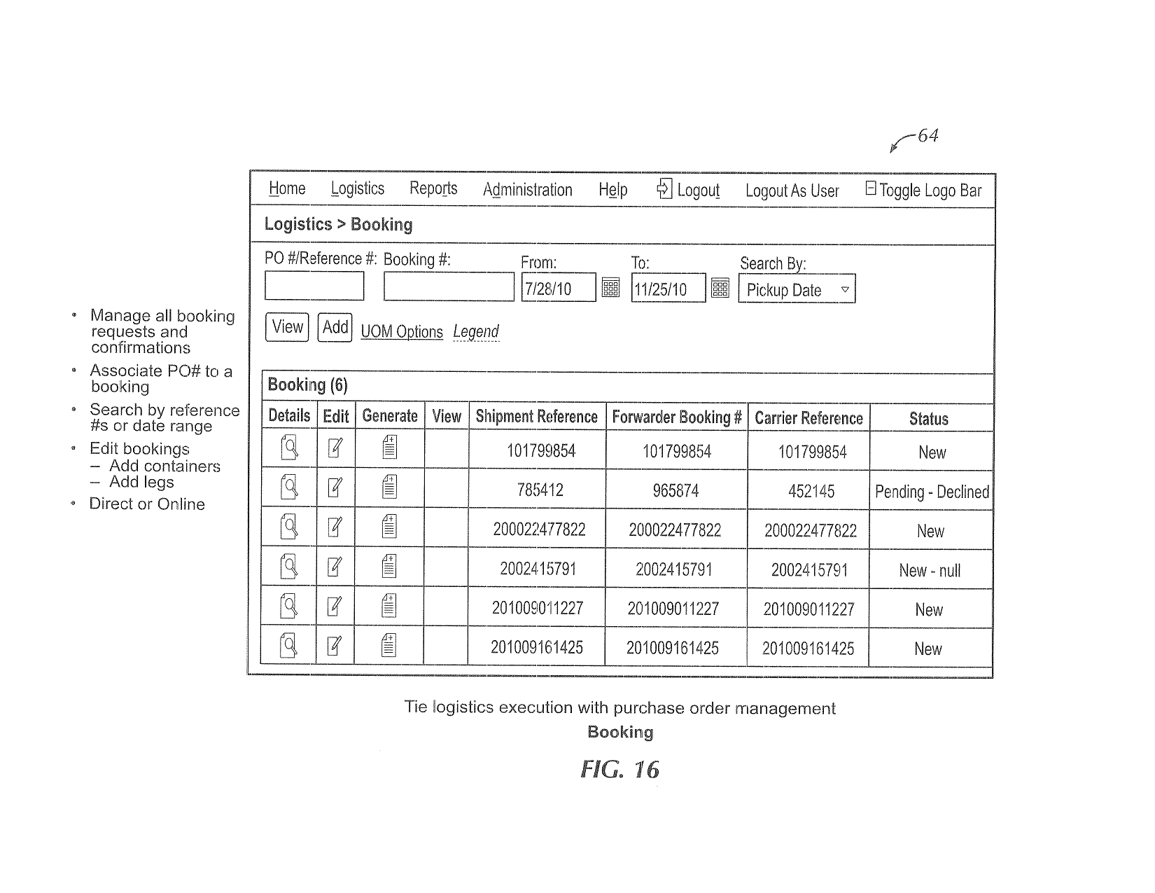

Referring to FIG. 16, a booking GUI 64 is preferably available through the central server 18, 18′ that permits management of all booking requests and confirmations. The booking GUI 64 preferably permits association of a purchase order number to a booking and searching by reference number or date range for specific bookings. The booking GUI 64 of the preferred embodiments also permits editing by adding containers and legs and access to the booking GUI 64 is preferably available direct through the hub or online through the portal. The booking GUI 64 is generally utilized to tie execution with purchase order management.

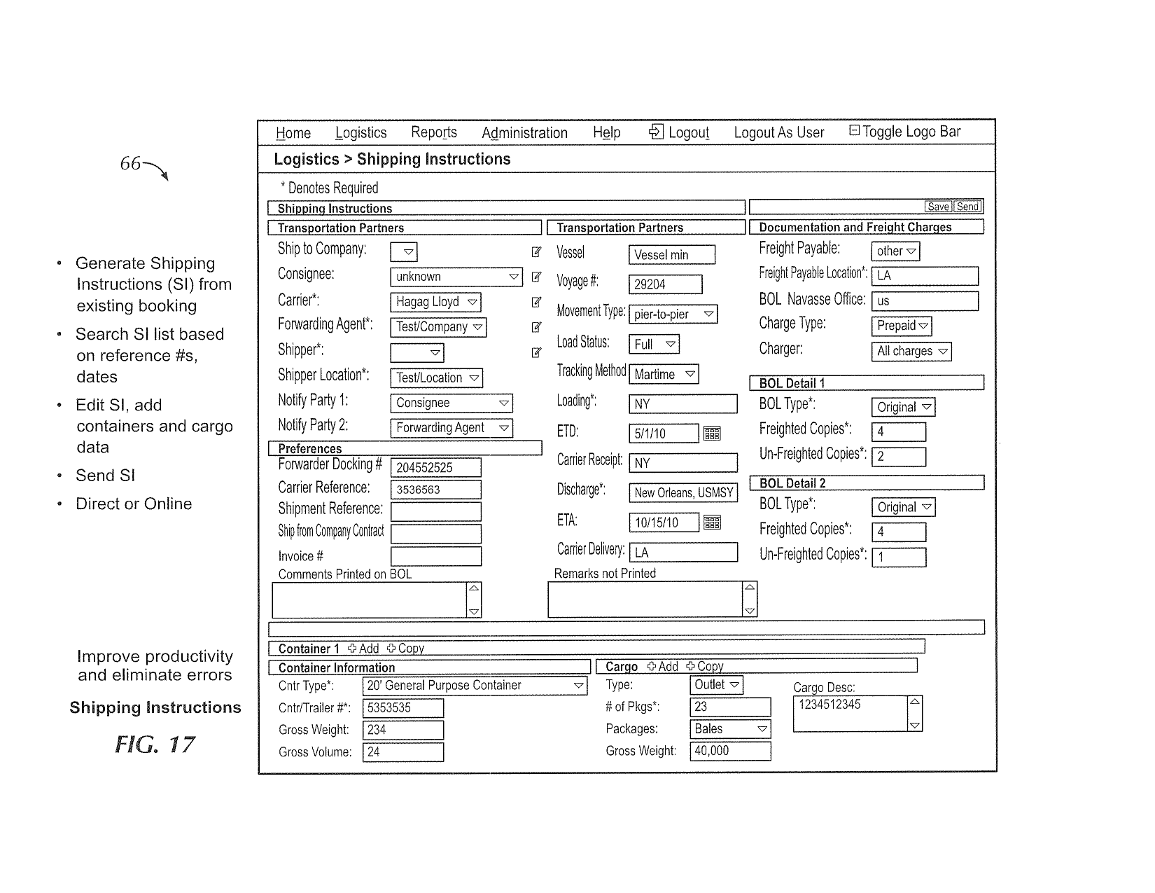

Referring to FIG. 17, a shipping instructions GUI 66 is preferably provided through the central server 18, 18′ and permits generation of shipping instructions from existing bookings and lists and permits searching of shipping instructions based on reference numbers and dates. The shipping instructions GUI 66 also preferably permits editing of the shipping instructions, such as by adding containers and cargo data, sending of shipping instructions and access to these features online or direct through the portal and/or hub. The shipping instructions GUI 66 is preferably able to improve productivity and eliminate or reduce errors in the shipping process for the network members 11, 11′, 12, 12′, 14, 14′, 20, 13.

The preferred systems 10, 10′ also preferably are designed and configured to create BOL master forms from shipping instruction data or from scratch. The systems 10, 10′ preferably facilitate collaboration on changes among stakeholders, such as origin control and creation of an electronic paper trail of changes. The central server 18, 18′ facilitates the negotiation and approval process with all collaboration partners for the BOL master document. The central server 18, 18′, following approval of the master BOL, transmits the approved BOL to specified parties of the collaboration partners, by rule or manually by shipment. The approved BOL's are preferably searchable, viewable and editable once stored in the central server 18, 18′. Alerts and notifications related to different steps in the negotiation and approval and tracking of the BOL are also available, as well as printing of the approved BOL master. The BOL master collaboration facilitated by the central server 18, 18′ preferably eliminates or greatly reduces miscommunications, phone calls, faxes and errors in shipping documents.

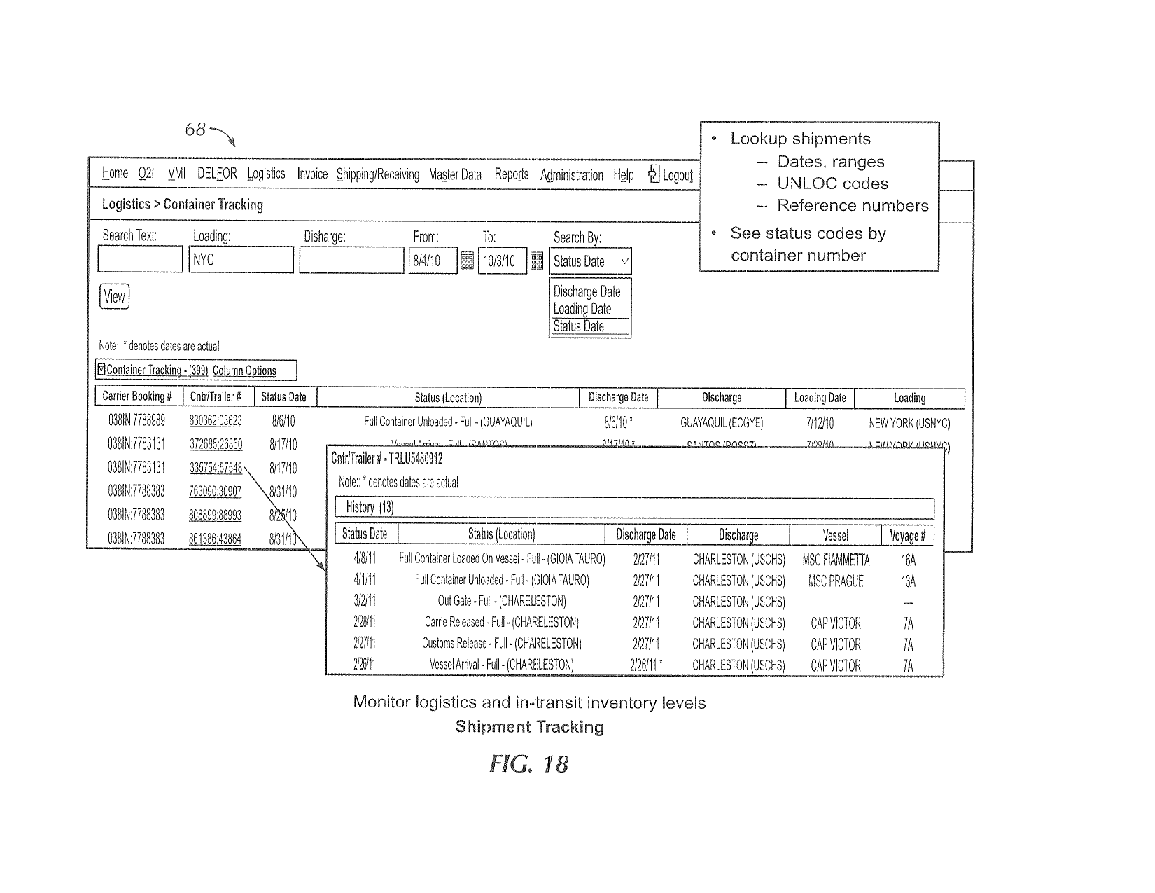

Referring to FIG. 18, a container tracking or shipment tracking GUI 68 permits searching of containers and shipments by dates, ranges, UNLOC codes, reference numbers or other identifiers. The preferred shipment tracking or container tracking GUI 68 permits viewing or monitoring of logistics and in-transit inventory levels by the consignee 11, 11′ and shipper 14, 14′.

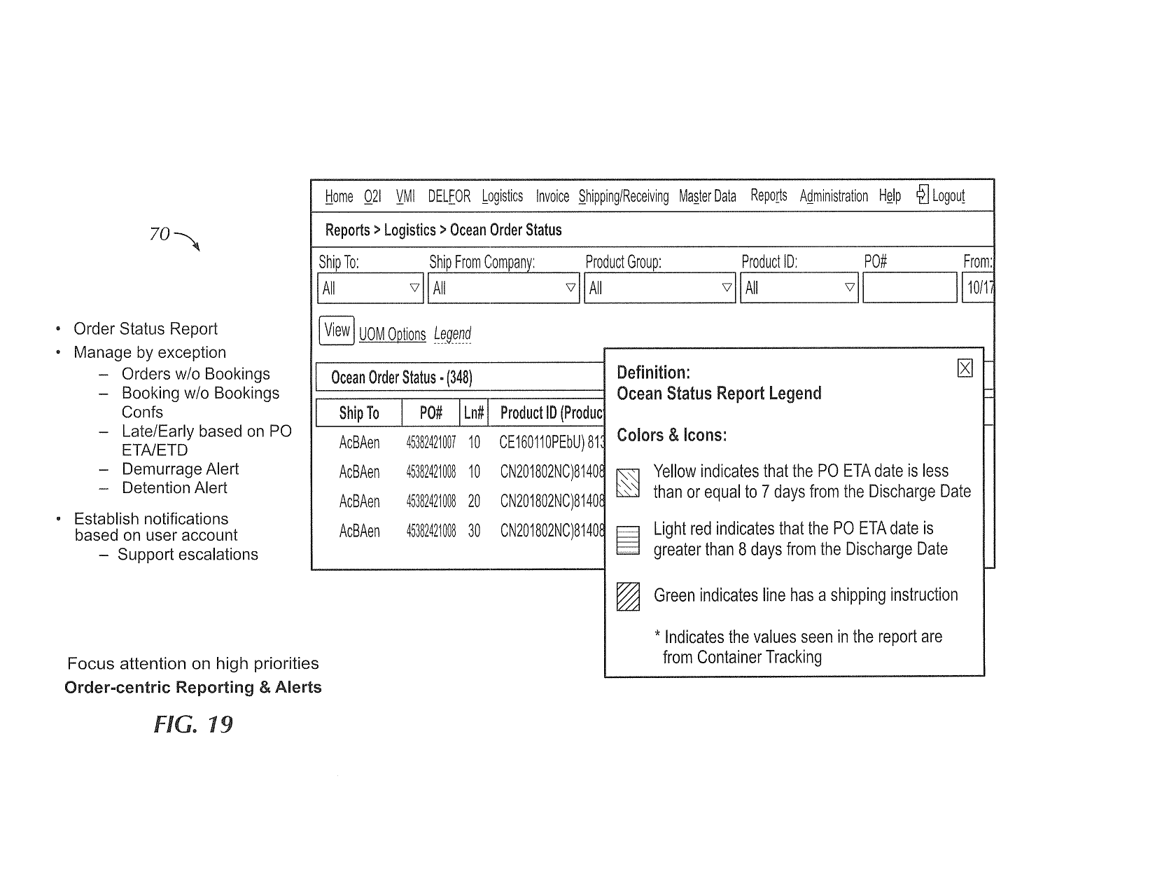

Referring to FIG. 19, order-centric reporting and alerts permits trading members to focus on high priority shipments or items and a preferred order status GUI 70 may be utilized to facilitate this reporting and alert scheme. The reporting and alerts are preferably color coded, for example, yellow may indicate that a purchase order estimated time of arrival date is less than or equal to seven (7) days from the discharge date, light red may indicate that the purchase order estimated time of arrival date is greater than eight (8) days from the discharge date and green may indicate that the line has a shipping instruction. Identifiers such as a star may be utilized to indicate that the values in the report are from container tracking and may be more or less reliable than other non-designated values. The order status GUI 70 also preferably permits management by exception of orders without bookings, booking without booking confirmations, late/early shipments based on purchase order estimated time of arrival or estimated time of delivery, demurrage issues or detention issues. The particular alerts may be customized based upon a user's account and are preferably managed and set up by the controller 20.

The preferred systems 10, 10′ provide a single point of connectivity for monitoring shipments and data for the members of the trading network, relatively simple connectivity and simple interfaces. The automation and connectivity of the preferred systems 10, 10′ speeds up booking and documentation processes and enables management by exception.

Optimization is provided by the preferred systems 10, 10′ by constructing a model using the lanes that are in the space (the annual estimated volume on each lane is the capacity to fill), the bids submitted by the carriers 12, 12′ for the chosen event and round (the rates in capacity commitment) and business constraints of the trading members, which may be implemented as rules by the controller 20. The optimizer of the central server 18, 18′ is preferably able to find the optimal linear (fractional) solution that solves the problem and the solution is nothing more than the volume that should be awarded to each carrier 12, 12′ on each lane in the scope of the event. Since awarding a fraction of the container or truck load to the carrier 12, 12′ doesn't make sense, the optimizer is preferably designed and configured to find the lowest integer solution to the problem. The central server 18, 18′ preferably calculates the lowest-cost integer solution, records the solution and transmits the proposed solution to the appropriate trading member for review, analysis, rejection and/or approval.

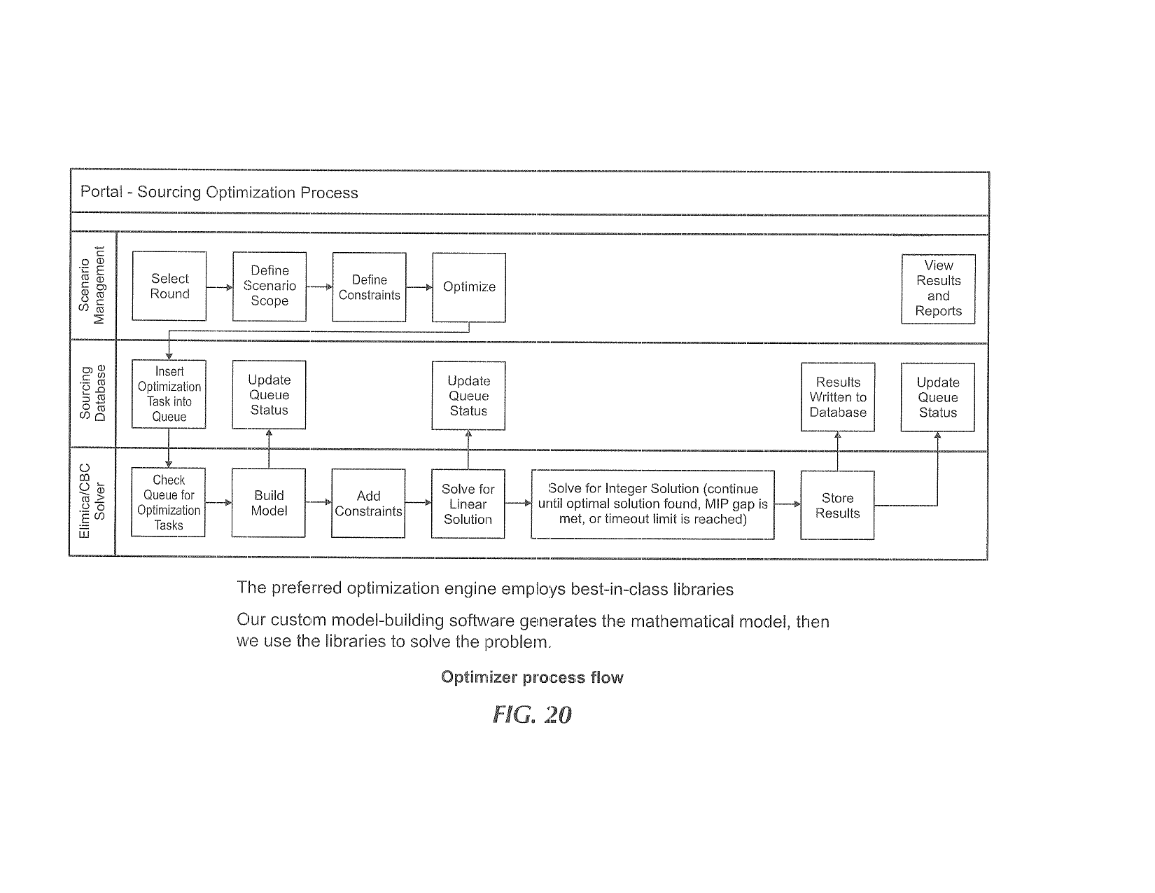

Referring to FIG. 20, the optimizer process flow is shown and includes scenario management, sourcing database and the solver of the central server 18, 18′. The mathematical model is built into the central server 18, 18′ and libraries are utilized to solve the problem based on the scenario, the constraints and how to optimize based on the scenario and constraints.

There are preferably at least fourteen (14) constraints commonly used with the preferred systems 10, 10′, but the systems 10, 10′ are not so limited and there may be more or less constraints. Preferred constraints include favor, maximum number of carriers, minimum number of carriers, penalize, set maximum award, set maximum number of bids, set maximum number of bids per lane, set maximum total award, set maximum volume award per bid, set minimum award, set minimum number of bids, set minimum number of bids per lane, set minimum total award and set minimum volume award per bid. Based upon the arrangement of the constraints and the scope of the event, a problem may include no solution and be considered infeasible. Such scenarios are identified to the appropriate trading member for modification or editing of constraints. In the preferred embodiments, the favor constraint improves a carrier's chance of winning on a lane, a penalized or penalty constraint decreases a carrier's chance of winning on a lane, a limit minimum/maximum number of carriers ensures a small or large group of awarded carriers, a set minimum/maximum award controls how much volume spend is awarded, a set minimum/maximum number of bids controls how many carriers 12, 12′ are awarded on the lanes in the scope, a set minimum/maximum number of bids per lane controls how many carriers 12, 12′ are awarded per lane, the set minimum/maximum total award controls the volume/spend awarded to the particular carrier 12, 12′ and the set minimum/maximum volume awarded per bid controls volume/spend awarded per lane to the carriers 12, 12′.

Constraints are preferably created by selecting a constraint type and entering a constraint value based upon the variety of constraints selected. The constraint will preferably impact every lane in the scenario and may be narrowed if desired. For example, the scope of the constraint can be narrowed to determine which lanes and bids will be impacted by the constraint. The scope may be narrowed based on origin, destination, volume, carrier, lane attributes or otherwise. The central server 18, 18′ preferably provides a visual description of the updated constraint in plain English regarding what the particular constraints is impacting. Constraints are preferably enforced mathematically by the central server 18, 18′ by translating the English language constraints into mathematical rules that become part of the shipping problem being solved. The constraints are preferably cumulative and default or base line constraints are preferably included in the central server 18 18′. Such default or base line constraints may be implemented for all scenarios by the controller 20. For example, a default constraint of the preferred system 10, 10′ may direct the system 10, 10′ to meet the capacity of the lanes in scope and minimize total costs. Generally, the default constraints strive for an absolute minimum cost achievable given rate and capacity commitments submitted by carriers 12, 12′ for a round being optimized. Unmet capacity on a lane is picked up by an imaginary carrier called a slack carrier in the preferred system 10, 10′. A default constraint may also be comprised of awarding the shipment to the first carrier 12, 12′ when the first and a second carrier 12, 12′ place identical bids that are accepted or selected.

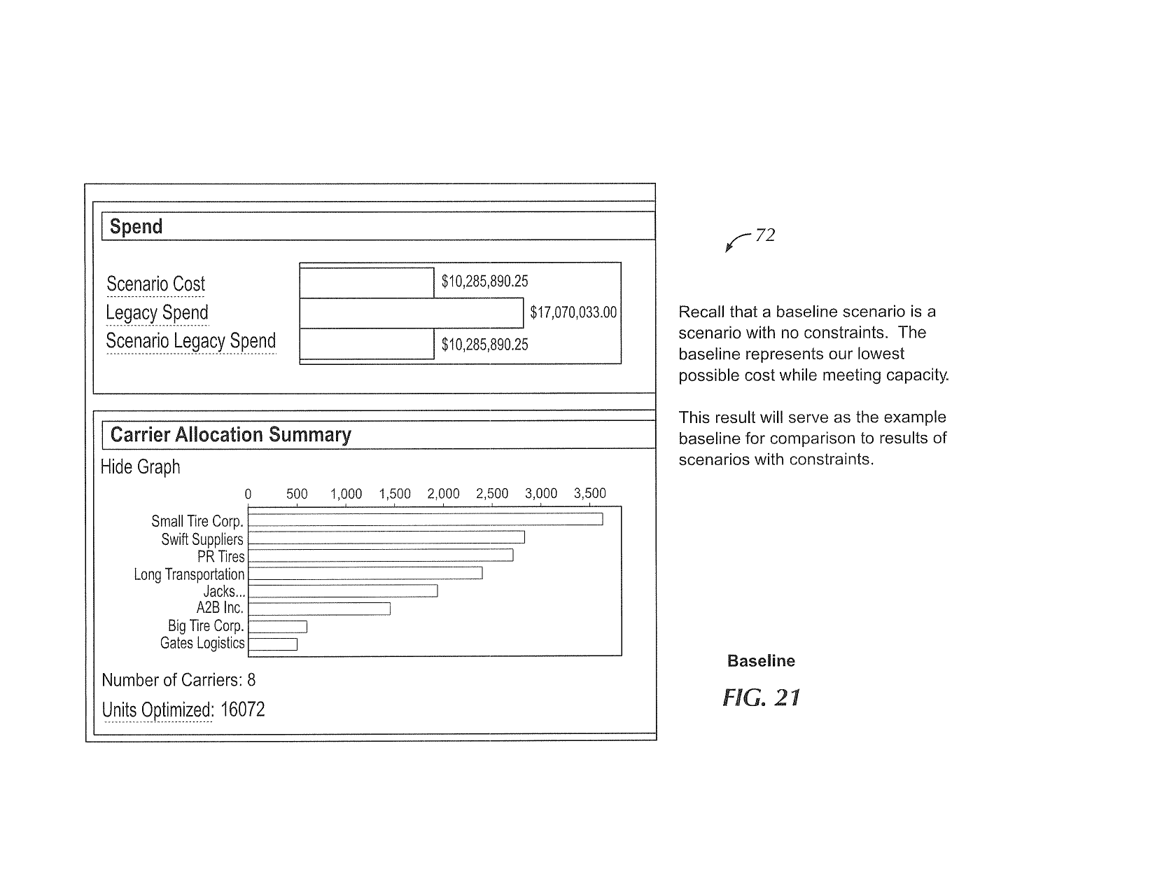

Referring to FIG. 21, a preferred spend GUI 72 displays a shipper's spending on all shipments in the trading network and provides a carrier allocation summary. The preferred spend GUI 72 of FIG. 21 represents a baseline scenario with no constraints. The baseline represents the lowest possible cost while meeting capacity. This result preferably serves as the example baseline for comparison to results of scenarios with constraints.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of managing logistics sourcing decisions including shipping rates in a logistics management network having a consignee, a shipper and a plurality of carriers for shipping freight from the shipper to the consignee, the method comprising:
a) transmitting, by a central server, a shipping bid to the plurality of carriers;
b) receiving, at the central server, a plurality of bid responses from the plurality of carriers in response to the shipping bid, the plurality of bid responses including at least a first bid having a first shipping rate and a first expiration date from a first carrier;
c) receiving, at the central server, a shipping constraint from the shipper;
d) determining, by the central server, whether the plurality of bid responses meet the shipping constraint to identify a rejected bid of the plurality of hid responses, the central server transmitting a rejection notification to a rejected carrier of the plurality of carriers associated with the rejected bid;
e) determining, by the central server, whether the plurality of bid responses meet the shipping constraint to identify a plurality of accepted bids of the plurality of bid responses, the central server transmitting a plurality of acceptance notifications to a plurality of accepted carriers of the plurality of carriers, the plurality of accepted bids including at least the first bid;
f) storing, at the central server, the plurality of accepted bids from step (e), the plurality of accepted bids stored until at least their respective expiration dates;
g) receiving, by the central server, a selected bid of the plurality of accepted bids of step (f), the selected bid comprised of the first bid;
h) transmitting, by the central server, a booking request to the first carrier; and
i) receiving, at the central server, tracking information related to the freight being shipped by the first carrier to the consignee including a ship date when the freight is received by the first carrier and a receipt date when the freight is delivered to the consignee.

2. The method of claim 1, wherein the plurality of carriers includes a land carrier and an ocean carrier, the ship date comprised of a land ship date when the freight is received by the land carrier, the central server further receiving, in step (i), an ocean receipt date when the freight is delivered to the ocean carrier by the land carrier, the first carrier comprised of the land carrier and the ocean carrier.

3. The method of claim 1, wherein the shipping constraint includes an origin, a destination, a carrier preference, a rate limit and a carrier type.

4. The method of claim 3, wherein the origin is comprised of a shipper address of the shipper, the destination is comprised of a consignee address of the consignee, the carrier preference is one of a land carrier, an ocean carrier and an air carrier and the rate limit is comprised of a maximum shipping rate.

5. The method of claim 3, wherein the carrier preference is comprised of identifying only the first carrier and a second carrier in step (e) when the origin is a predetermined country.

6. The method of claim 1, further comprising:
j) receiving, at the central server, a volume of freight shipped by at least the first carrier, a second carrier, a third carrier, a fourth carrier and a fifth carrier for the shipper; and
k) determining, by the central server, a listing of top five carriers by volume.

7. The method of claim 1, wherein the shipping constraint includes a geographic filter.

8. The method of claim 1, wherein the central server also receives a second bid in step (b), the second bid having a second shipping rate and a second expiration date from a second carrier, the second hid comprising one of the plurality of accepted bids.

9. The method of claim 1, comprising the further step of:
j) storing, by the central server, the first bid, the ship date and the receipt date, at least until the first expiration date.

10. The method of claim 9, comprising the further step of:
k) sending a signal, by the central server, to display active events, which comprise events that are in process in steps (g)-(j).

11. The method of claim 1, wherein the shipping constraint includes at least an origin and a destination, the central server sending a signal to display stored rate information that satisfies the shipping constraint prior to step (e).

12. A method of managing logistics sourcing decisions including shipping rates in a logistics management network having a consignee, a shipper and a plurality of carriers for shipping freight from the shipper to the consignee, the method comprising:
a) transmitting, by a central server, a shipping bid to the plurality of carriers;
b) receiving, at the central server, a plurality of bid responses from the plurality of carriers in response to the shipping bid, the plurality of bid responses including at least a first bid having a first shipping rate and a first expiration date from a first carrier;
c) receiving, at the central server, a shipping constraint from the consignee;
d) determining, by the central server, whether the plurality of bid responses meet the shipping constraint to identify a rejected bid of the plurality of bid responses, the central server transmitting a rejection notification to a rejected carrier of the plurality of carriers associated with the rejected bid;
e) determining, by the central server, whether the plurality of bid responses meet the shipping constraint to identify a plurality of accepted bids of the plurality of bid responses, the central server transmitting a plurality of acceptance notifications to a plurality of accepted carriers of the plurality of carriers, the plurality of accepted bids including at least the first bid;
f) storing, at the central server, the plurality of accepted bids from step (e), the plurality of accepted bids stored until at least their respective expiration dates;
g) receiving, by the central server, a selected bid of the plurality of accepted bids of step (f), the selected bid comprised of the first bid;
h) transmitting, by the central server, a booking request to the first carrier; and
i) receiving, at the central server, tracking information related to the freight being shipped by the first carrier to the consignee including a ship date when the freight is received by the first carrier and a receipt date when the freight is delivered to the consignee.

13. The method of claim 12, comprising the further step of:
j) storing, by the central server, the first bid, the ship date and the receipt date, at least until the first expiration date.

14. The method of claim 13, comprising the further step of:
k) sending a signal, by the central server, to display active events, which comprise events that are 111 process 111 steps (g)-(j).

15. The method of claim 12, further comprising:
j) receiving, at the central server, a volume of freight shipped by at least the first carrier, a second carrier, a third carrier, a fourth carrier and a fifth carrier for the shipper; and
k) determining, by the central server, a listing of top five carriers by volume.
